(19) United States
(12) Patent Application Publication
(10) Pub. No.: US 2018/0200680 A1
(43) Pub. Date: Jul. 19, 2018

(54) Composite Membrane and Method of Fabricating the Same

(71) Applicants: CO2 M-Tech Co., Ltd., Tokyo (JP); Kyoto University, Kyoto (JP)

(72) Inventors: Easan Sivaniah, Kyoto (JP); Behnam Ghalei, Kyoto (JP); Youfeng Yue, Kyoto (JP)

(73) Assignees: CO2 M-Tech Co., Ltd., Tokyo (JP); Kyoto University, Kyoto (JP)

(21) Appl. No.: 15/744,377

(22) PCT Filed: Jul. 12, 2016
(86) PCT No.: PCT/JP2016/003306

§ 371 Date: Jan. 12, 2018

(30) Foreign Application Priority Data
Jul. 13, 2015 (JP) 2015-139963

(51) Int. Cl. B01D 71/60; B01D 67/00; B01D 69/12; B01D 71/44; B01D 71/62

(52) U.S. Cl. CPC B01D 71/60; B01D 67/0006; B01D 67/0093; B01D 69/125; B01D 2323/40; B01D 71/62; B01D 2325/20; B01D 2325/16; B01D 71/44

(57) ABSTRACT

Disclosed is a composite membrane including a polymeric membrane having an H₂ permeability of 500 Barrer or more at 25 degrees C., and a coating layer deposited on the polymer membrane by oxidative polymerization.

### TECHNICAL FIELD

The present invention relates to a composite membrane and a method of fabricating the same. The present invention also relates to a method of separating H₂ from a mixed gas using the composite membrane.

### BACKGROUND ART

Cogeneration of power and hydrogen through coal gasification coupled with carbon dioxide capture will play an important role in future energy sustainability. The current technologies for hydrogen production and carbon dioxide separation are typically less economical than conventional energy production methods.

Hydrogen separation membranes represent a potential option due to their unique characteristics of simple operation, high energy efficiency and environmental friendliness compared to the other available technologies such as pressure swing adsorption (PSA) and cryogenic distillation.

Polymeric membranes are commercially available (see Non-patent Literature 1). Polymer materials are required to have high permeability and good selectivity for a desired separation. Microporous polymers are highly permeable polymers with rigid macromolecular backbones and high fraction of microvoids. Examples include substituted polyacetylenes (poly(1-trimethylsilyl-1-propyne) [PTMSP]), and polymers of intrinsic microporosity (PIMs).

PIMs contain interconnected regions of micropores with high gas permeability but with a controlled level of heterogeneity that compromises molecular selectivity (see Non-patent Literature 2). Membranes of the polymers of intrinsic microporosity possess superior H₂ and CO₂ permeabilities of around 1000 to 2000 and 3500 to 5000 Barrer, respectively (see Non-patent Literature 3 to 5), and a relatively low H₂/CO₂ selectivity of 0.5 to 0.8.

Various modification strategies in polymer membranes have been used to achieve high pair gas selectivities, such as polymer blending, surface functionalization, thermal treatment, chemical and UV cross-linking, and inorganic particle filling. The most recent PIM modifications have focused on improving its CO₂/CH₄ and CO₂/N₂ selectivities.

### CITATION LIST

### Non Patent Literature

NPL 1: Rand, D. A. J., et al., Hydrogen Energy: Challenges and Prospects, RSC Publishing, Cambridge, UK, 2008
NPL 2: Budd, P. M., et al., J. Membr. Sci., 2005, 251, 263-269
NPL 3: McKeown, N. B., et al., Chem. Soc. Rev. 2006, 35, 675-683
NPL 4: Carta, M., et al., Science, 2013, 339, 303-307
NPL 5: Shao, L., et al., J. Membr. Sci., 2009, 327, 18

### SUMMARY OF INVENTION

### Technical Problem

It is desirable to provide a membrane that can be used to separate H₂ from a mixed gas with high selectivity.

### Solution to Problem

An aspect of the present invention provides a composite membrane comprising: a polymeric membrane having an H₂ permeability of 500 Barrer or more at 25 degrees C.; and a coating layer for controlling pair gases selectivities deposited on the polymer membrane. The coating layer is formed by oxidative polymerization.

### Advantageous Effects of Invention

A membrane is provided that can be used to separate H₂ from a mixed gas with high selectivity.

### BRIEF DESCRIPTION OF DRAWINGS

FIG. 1 is a cross-sectional view of an embodiment of a composite membrane.

FIG. 2 is a schematic view showing an embodiment of a method of fabricating a composite membrane.

FIG. 3 is FT-IR spectra of PDA.

FIG. 4 is FT-IR spectra of PANIs.

FIG. 5 is ATR-FTIR spectra of a PIM-1 membrane and PIM-1/PDA composite membranes.

FIG. 6 is ATR-FTIR spectra of a PIM-1 membrane and PANI/PDA composite membranes.

FIG. 7 is a SEM image of a PIM-1/PDA composite membrane.

FIG. 8 is a SEM image of a PIM-1/PDA composite membrane.

FIG. 9 is a SEM image of a PIM-1/PDA composite membrane.

FIG. 10 is a SEM image of a PIM-1/PDA composite membrane.

FIG. 11 is a SEM image of a PIM-1/PDA composite membrane.

FIG. 12 is a SEM image of a PIM-1/PDA composite membrane.

FIG. 13 is a SEM image of a PIM-1/PANI composite membrane.

FIG. 14 is a SEM image of a PIM-1/PANI composite membrane.

FIG. 15 is a SEM image of a PIM-1/PANI composite membrane.

FIG. 16 is a SEM image of a PIM-1/PANI composite membrane.

FIG. 17 is a graph showing relationships between H₂/N₂ selectivity and H₂ permeability for various polymer membranes including PIM-1/PDA composite membranes.

FIG. 18 is a graph showing relationships between H₂/CH₄ selectivity and H₂ permeability for various polymer membranes including PIM-1/PDA composite membranes.

FIG. 19 is a graph showing relationships between H₂/CO₂ selectivity and H₂ permeability for various polymer membranes including PIM-1/PDA composite membranes.

FIG. 20 is a graph showing relationships between H₂/N₂ selectivity and H₂ permeability for various polymer membranes including PIM-1/PANI composite membranes.

FIG. 21 is a graph showing relationships between H₂/CH₄ selectivity and H₂ permeability for various polymer membranes including PIM-1/PANI composite membranes.

FIG. 22 is a graph showing relationships between H₂/CO₂ selectivity and H₂ permeability for various polymer membranes including PIM-1/PANI composite membranes.

FIG. 23 is a graph showing pressure dependence of H₂ permeability and H₂/CO₂ selectivity from H₂/CO₂ mixed gas through a PIM-1 membrane and PIM-1/PDA or PIM-1/PANI composite membranes.

FIG. 24 is a graph showing ideal selectivity of PTMSP/PDA composite membranes.

FIG. 25 is a graph showing ideal selectivity of PTMSP/PANI composite membranes.

FIG. 26 is a SEM image of a cross section of a PIM/PDA composite membrane.

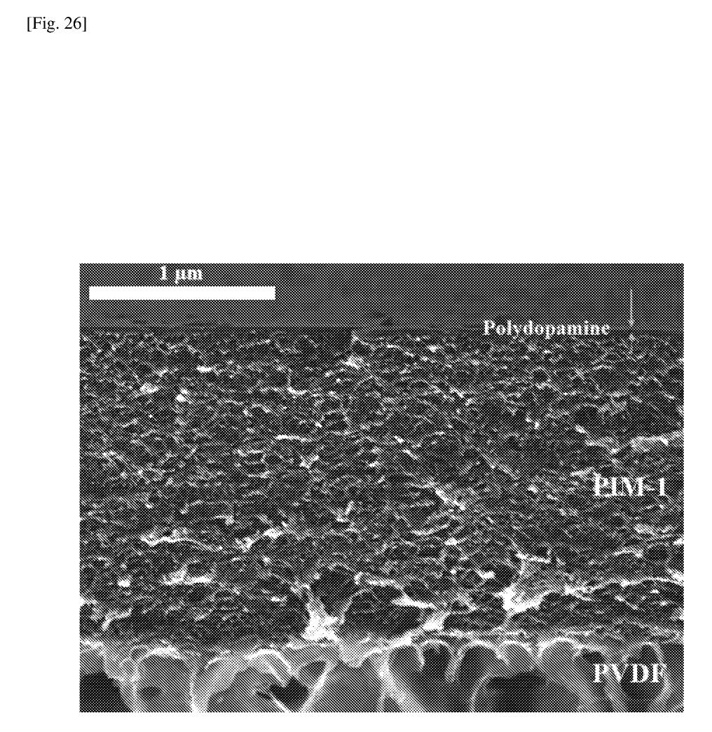

### DESCRIPTION OF EMBODIMENTS

Embodiments of the present invention will now be described. The present invention, however, is not limited to the following embodiments.

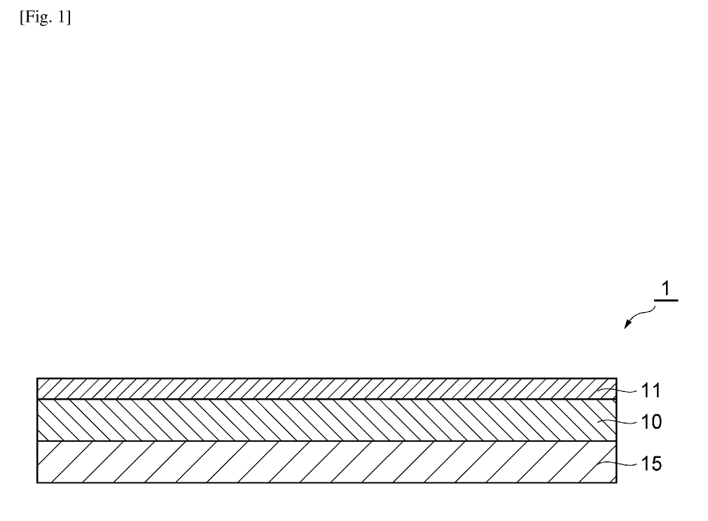

FIG. 1 is a cross-sectional view showing an embodiment of a composite membrane. The composite membrane 1 shown in FIG. 1 comprises a polymeric membrane 10, a coating layer 11 provided on a surface of the polymeric membrane 10, and a porous substrate 15. The polymeric membrane 10 and the coating layer 11 are laminated in this order on a surface of the porous substrate 15.

The polymeric membrane 10 has a relatively high H₂ permeability, e.g. of 500 Barrer or more, 1000 Barrer or more, or 1500 Barrer or more at 25 degrees C. The H₂ permeability may be 3000 Barrer or less at 25 degrees C. Details of a method of determining the H₂ permeability will be described hereinafter in the examples.

The polymeric membrane 10 with the relatively high H₂ permeability allows the coating layer 11 to be made thin. The deposition of thin coating polymer layer 11 on the surface of the membrane 10 would provide direct benefits in the control of gases diffusivity and sieving properties of the membrane 10 and consequently achieving high H₂ selectivity without significant decrease in the permeability of the membrane 10. A substantially defect free thicker coating layer 11, which is difficult to form independently without the polymeric membrane 10, results in higher pair gas selectivity Despite high separation factors of the coating layer 11, the commercial possibility as an outstanding gas separation membrane is impossible due to order of magnitude lower permeability than commercial membranes. One of the promising approach is to deposit the thin layer of coating layer 11 on to a high permeable membrane 10. The polymeric membrane 10 does not need to have a high H₂ selectivity.

Examples of polymeric materials that can form the polymeric membrane 10 with the relatively high H₂ permeability include polymers of intrinsic microporosity. This type of polymer may include a constitutional unit represented by the following formula (I):

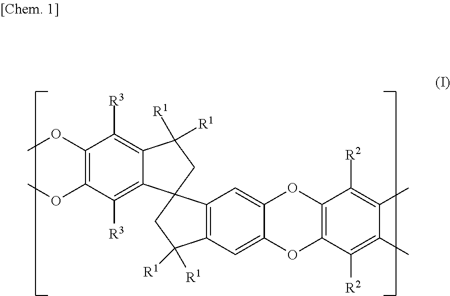

wherein R¹ is a hydrogen atom or a linear or branched C₁-C₅ alkyl group, R² is a hydrogen atom, a linear or branched C₁-C₅ alkyl group, or a cyano group, R³ is a hydrogen atom, a linear or branched C₁-C₅ alkyl group, or a cyano group. A plurality of R¹, R², and R³ in the same constitutional unit may be the same or different, respectively. A polymer of intrinsic microporosity having the constitutional unit of (I) where R¹ are methyl groups, R² are cyano groups and R³ are hydrogen atoms, referred as “PIM-1”.

Another example of polymeric material that can form the polymeric membrane 10 with the relatively high H₂ permeability is a polymer including a constitutional unit represented by the following formula (II):

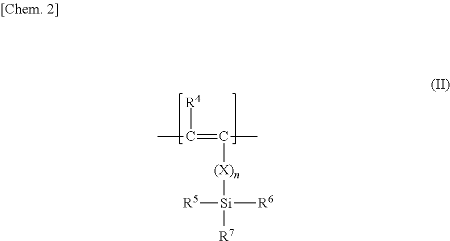

wherein R⁴ is a linear or branched C₁-C₄ alkyl group, R⁵ and R⁶ are independently a linear or branched C₁-C₆ alkyl group, R⁷ is a linear or branched C₁-C₃ alkyl group or an aryl group, X is a C₁-C₃ alkylene group or a group represented by the following formula (10):

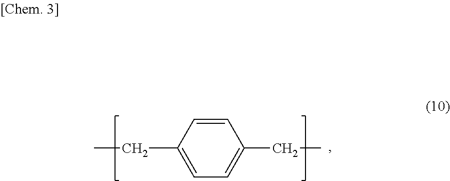

and n is 0 or 1.

Examples of the polymer including the structure of formula (II) include poly((1-trimethyl-silyl)propine) in which R⁴ is a methyl group, R⁵, R⁶ and R⁷ are methyl groups, and n is 0. This polymer referred as “PTMSP”.

The thickness of the polymeric membrane 10 may be 0.2 micrometers or more. The thickness of the polymeric membrane 10 may be 100 micrometers or less. A thinner polymeric membrane 10 results in a composite membrane with higher gas permeance. A thin polymeric membrane 10 can be easily formed on the porous substrate 15. When the porous substrate 15 is not provided and the polymeric membrane 10 is self-supported, the thickness of the polymeric membrane 10 may be 20 micrometers or more.

The gas permeability of polymeric membrane 10 itself typically follows the sequence of P (CO₂)>P (H₂)>P (O₂)>P (CH₄)>P (N₂). This permeability order is mainly due to the interplay between the diffusivity, kinetic diameter, the solubility, and the critical temperature of the gas molecules in polymer matrix. For example, higher CO₂ permeability is related to higher solubility of CO₂ in the membrane compared to other gases as well as small kinetic diameter.

The polymeric membrane 10 can be prepared by typical methods such as solution casting and solvent evaporation technique.

The coating layer 11 covers at least one primary surface of the polymeric membrane 10. The coating layer 11 may be formed by oxidative polymerization, which includes at least a step of performing an oxidation reaction of a monomer. Oxidative polymerization may be conducted while exposing the surface of the polymeric membrane to a monomer solution. Such oxidative polymerization reaction makes it possible to form a sufficiently thin coating layer with fewer defects.

Examples of polymers that constitute the coating layer 11 include polydopamine (PDA), and aniline-based polymers (PANI).

PDA is a polymer of dopamine and is formed through the following reactions from dopamine as a monomer:

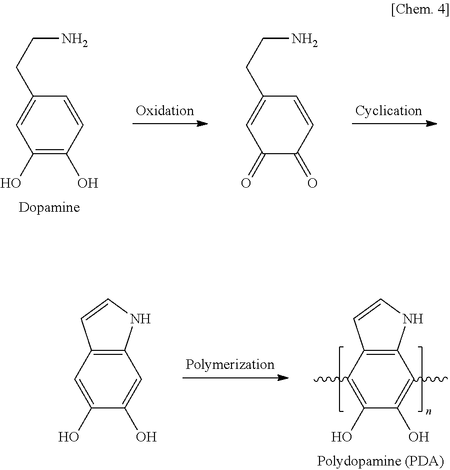

The coating layer 11 that is comprised of PDA can be formed by a method comprising steps such as: preparing an aqueous dopamine solution with a predetermined pH; and polymerizing dopamine while exposing the surface of the polymeric membrane 10 to the aqueous dopamine solution, thereby depositing PDA on the surface of the polymeric membrane 10. The temperature of the aqueous dopamine solution during polymerization may be 25 degrees C. to 35 degrees C.

The aqueous dopamine solution for polymerization can be prepared, for example, by dissolving dopamine hydrochloride in Tris-HCl buffer. The pH of the polymerization solution may be adjusted to around 7.5 to 9.5 prior to use. The concentration of dopamine in the dopamine solution may be about 1 to 10 mg/ml. This concentration is defined as a ratio with respect to the total volume of the dopamine solution.

The aniline-based polymer contains at least one of an aniline or an aniline derivative as a monomer unit. The monomer unit in the aniline-based polymer may form a salt with any acids such as hydrochloric acid (HCl). The aniline-based polymer may be a homopolymer of aniline or an aniline derivative, or a copolymer comprising aniline and/or an aniline derivative. As used herein, the terms PANI and PANIs mean an aniline-based polymer including aniline homopolymer, and homopolymers and copolymers that contain an aniline derivative as a monomer unit.

Examples of the aniline derivatives that can constitute PANIs include o-methoxyaniline (o-anisidine), m-fluoroaniline (F-aniline), m-aminophenyl boronic acid (APBA) and combinations thereof.

The ratio of comonomer units derived from aniline may be 0 mol % or more, with respect to the total monomer units of PANI. The ratio of comonomer units derived from aniline may be 100 mol % or less with respect to the total monomer units of the PANI.

The coating layer 11 that is comprised of the PANI can be formed by a method comprising steps such as: preparing an aqueous aniline monomer solution containing at least one monomer selected from aniline and other aniline derivative with a predetermined pH; and polymerizing the aniline monomer while exposing the surface of the polymeric membrane 10 to the aqueous aniline monomer solution, thereby depositing PANI on the surface of the polymeric membrane 10. The temperature of the aqueous aniline monomer solution during polymerization may be 0 degrees C. to 25 degrees C.

The initial pH of the aniline monomer solution may be adjusted to about 3 by addition of 1M HCl. The aqueous aniline monomer solution may further contain an oxidizing agent such as ammonium peroxodisulfate for oxidative polymerization of the aniline monomer. The concentration of the aniline monomer in the solution may be about 15 to 50 mg/ml. This concentration is defined as a ratio with respect to the total volume of the aniline monomer and oxidizing agent solution. The resulting coating layer may be doped with HCl, HBr or HI.

The thickness of the coating layer 11 may be 200 nm or less. The thickness of the coating layer 11 may be 20 nm or more. A thinner coating layer 11 results in a composite membrane with higher gas permeance, whereas a thicker coating layer 11 may result in higher H₂ selectivity.

The thickness of the coating layer 10 depends on polymerization time to form the coating layer. The polymerization time for PDA may be 15 minutes or more, and 300 minutes or less. The polymerization time for PANI may be 10 minutes or more, and 30 minutes or less.

The porous substrate 15 can be comprised of any porous material that allows gas to pass through with substantially no selectivity. The molecular weight cut-off (MWCO) of the porous substrate 15 may be 1 kDa or more, The MWCO of the porous substrate 15 may be 70 kDa or less. An example of the porous material is polyvinylidene difluoride (PVDF). The thickness of the porous substrate 15 may be 100 micrometers to 200 micrometers.

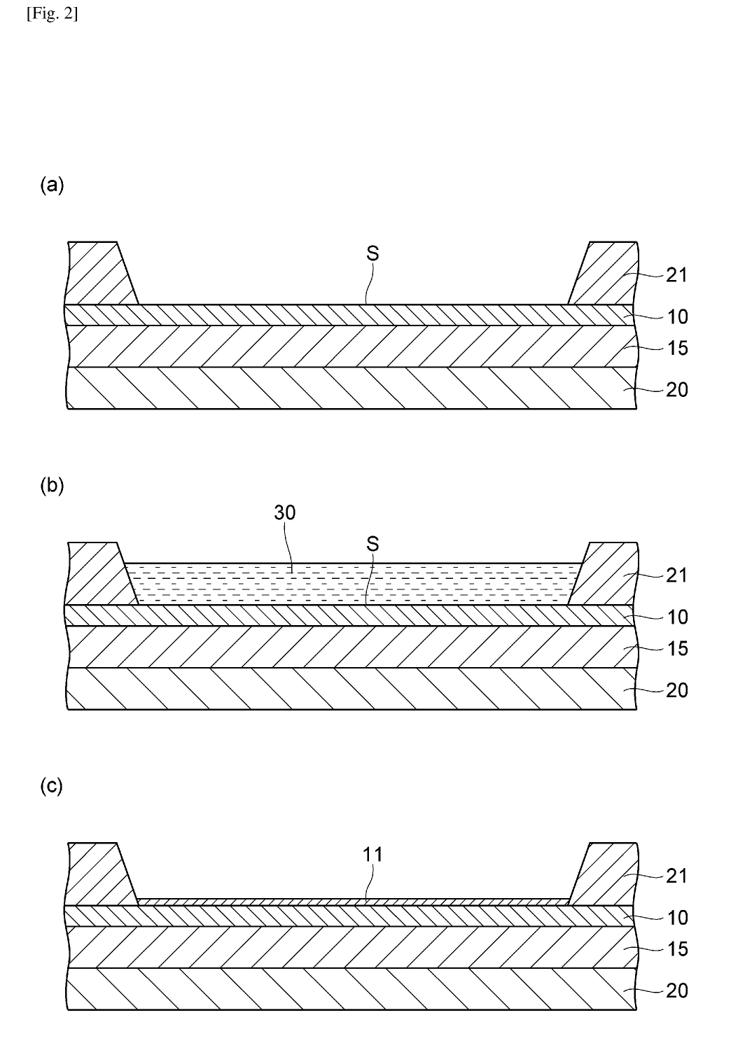

FIG. 2 is a schematic view showing an embodiment of a method of fabricating the composite membrane. A stacked structure constituted by the porous substrate 15 and the polymeric membrane 10 is sandwiched between a pair of holders 20 and 21. The holder 21 holds a peripheral edge of the stacked structure so that one primary surface S of the polymeric membrane 10 is exposed. Then monomer solution 30 used for oxidative polymerization is poured on a primary surface S of the coating layer 10. The holders 20 and 21 can prevent the monomer solution 30 from directly interacting with the porous substrate 15. After depositing the coating layer 11 by oxidative polymerization over a predetermined reaction time, the monomer solution 30 is removed and the resulting coating layer 11 is then dried.

The composite membrane 1 has high H₂ selectivity, and can be used in a method of separating H₂ from a mixed gas. The method comprises causing H₂ in the mixed gas to pass through the composite membrane 1. The mixed gas, from which H₂ is separated by the composite membrane, can be fed toward the coating layer 11. The temperature of the mixed gas that is in contact with composite membrane 1 may be 25 degrees C. to 65 degrees C.

The mixed gas may comprise any gas selected from, for example, the group consisting of CO₂, O₂, N₂, and a hydrocarbon such as CH₄. The composite membrane 1 is especially useful for separating H₂, since it has high H₂/CO₂, H₂/N₂ and H₂/CH₄ selectivities.

The structure of the composite membranes according to the present invention is not limited to the above. For example, the composite membrane may have coating layers on both main surfaces of the polymeric membrane. The composite membrane may not have the porous substrate.

### EXAMPLE

Hereinafter, the present invention is more specifically described using examples.

However, the present invention is not limited to these examples.

### 1. PIM-1/PDA or PIM-1/PANI Composite Membranes

1-1. PIM-1 Synthesis

The PIM-1 was synthesized according to the following polycondensation reaction between 5,5′,6,6′-tetrahydroxy-3,3,3′,3′-tetramethyl-1,1′-spirobisindane (TTSBI, 30 mmol, Sigma-Aldrich) and 2,3,5,6-tetrafluoroterephthalonitrile (TFTPN, 30 mmol, Wako Pure Chemical) in the presence of dried K₂CO₃ (60 mmol, Sigma-Aldrich) and anhydrous dimethylformamide (DMF, 200 mL, Wako Pure Chemical).

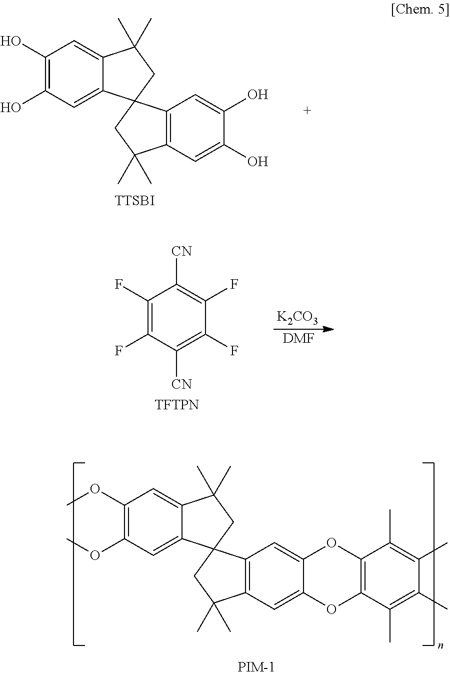

The reaction mixture was stirred under nitrogen atmosphere at 65 degrees C. for 60 h. Subsequently, the resulting polymer was purified by dissolving in chloroform and reprecipitating from methanol, filtered, and dried in a vacuum oven at 110 degrees C. overnight. The molecular weight of the purified polymer was determined by gel permeation chromatography (GPC), giving an average molecular weight of Mn=90,000 to 120,000 dalton and a polydispersity index (PDI) of 2.2 to 2.5.

1-2. PIM-1 Membrane Preparation

PIM-1 based polymeric membranes were prepared by solution casting and solvent evaporation technique. Casting solutions were prepared by dissolving the PIM-1 in chloroform at a total polymer concentration of 8 wt %, and continuously stirring at room temperature. Non-dissolved polymers were removed by filtration through PTFE filters or by centrifugation.

The resulting polymer solution was cast on a glass substrate and covered, within a clean chamber at room temperature under atmospheric pressure, in order to slowly evaporate the solvent. After 2 days, the resulting membrane was dried in a vacuum oven at 110 degrees C. overnight. Thickness of the membranes was around 80 micrometers as measured by a micrometer caliper. The average thickness of an individual membrane was measured based on the results of three separate thickness values at different points on the membrane surface.

1-3. PIM-1/PDA Composite Membrane Preparation

PIM-1 membranes were coated with polydopamine by exposing surfaces of the membranes to an aqueous dopamine solution at room temperature. Dopamine solutions with 1, 2 or 4 mg/mL concentration were prepared by dissolving dopamine hydrochloride in 10 mM Tris-HCl buffer. The pH of Tris-HCl buffer solutions was adjusted to 7.5, 8.5 or 9.5 by 0.5 M NaOH solution prior to use. The PIM-1 membranes were then immersed in the dopamine solution for 15, 30, 45, 60, 90, 120, 150, 180 or 230 min, thereby depositing polydopamine on both sides of the PIM-1 membrane to form a PDA coating layer. After the polydopamine deposition step was complete, the membrane was rinsed with ultrapure water for 5 minutes to remove unattached polydopamine from the membrane surface. Finally, the resulting composite membrane was dried in a vacuum oven at 100 degrees C. overnight.

1-4. PIM-1/PANI Composite Membrane Preparation

0.596 g of aniline was added to 20 ml distilled water to prepare an aqueous aniline solution. The initial pH of the solution was adjusted to 3 by addition of 1M HCl. The solution was cooled to 0 degrees C., and 20 ml of ammonium peroxodisulfate (0.1 M) solution was gradually added. The PIM-1 membranes were then immersed in the dopamine solution for 12, 14, 16, 18, 20, 22, 24, 26, 28 or 30 minutes, thereby depositing PANI on both sides of the PIM-1 membrane to form a PANI coating layer. The membranes were then soaked in 0.1 M ammonium hydroxide solution for 30 minutes and were rinsed with ultrapure water. The composite membranes were then doped by immersion of coated membrane in aqueous HCl, HBr or HI solutions (pH: 3) for 30 min. The resulting composite membranes doped with HCl, HBr or HI were dried in a vacuum oven at 100 degrees C. over night.

Under similar condition, copolymers of aniline and derivatives thereof, including o-methoxyaniline (O-Anisidine), m-fluoroaniline (F-aniline), and m-aminophenyl boronic acid (APBA), were prepared, with comonomer-to-aniline molar ratios of 1:3 or 1:1. The resulting membranes were doped with HCl.

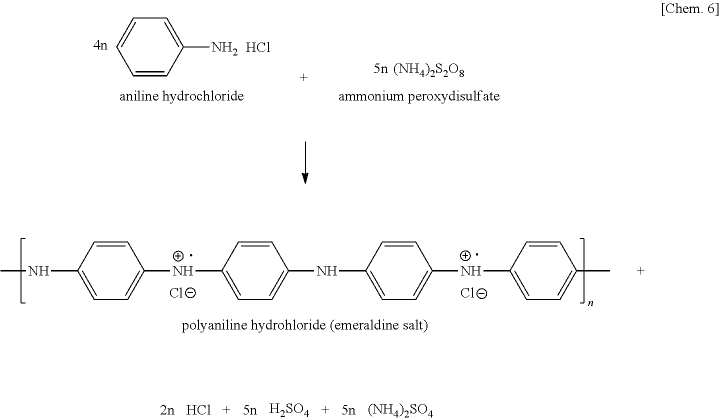

### 2. Characterization and Evaluation Methods

2-1. Membrane Characterization

Functional groups in synthesized PIM-1, PDA and PANI were investigated with a Fourier Transform Infrared spectrometer (FT-IR, Shimaduzo, IRTracer-100) in the range of 4000 to 500 cm⁻¹. All the films used for FT-IR measurement were prepared by casting 1 wt % polymer solutions on a KBr disc.

The surface and cross-section morphology of the composite membranes were observed with an FESEM (Hitachi S-4800, Japan) instrument. The cross-sections of membranes were obtained by fracturing the film in liquid nitrogen, and the fractured products were sputtered with platinum to prevent charging.

X-ray photoelectron spectroscopy (XPS, ULVAC-PHI MT-5500) instrument using Mg Kα (1254.0 eV) as a radiation source (the takeoff angle of the photoelectron was set at 90 degrees) was used to determine the composition of polydopamine and polyaniline coating layer on the PIM-1 surface. Survey spectra were collected over a range of 0 to 1100 eV, and high-resolution spectra of C1s peak were also collected.

The hydrophilicity of the membrane surface was characterized on the basis of static contact angle measurement using a contact angle goniometer (JC2000C, Japan) equipped with video capture. A piece of 2 cm² membrane was stuck on a glass slide and mounted on the goniometer. A total of 5 microliter of water was dripped onto the exposed side of the membranes with a micropipette at room temperature.

2-2. Gas Permeation Measurement

Pure gas permeabilities of the membranes were determined using a constant pressure/variable volume method at room temperature (25 degrees C.). The membrane was held in a Millipore commercial filter holder with steel meshed supports, and rubber O-rings were used for proper sealing. The membrane was evacuated with a vacuum pump (Edwards RV8) prior to gas permeation measurements. The gas permeate pressure were continuously recorded by pressure transmitters (Keller PAA 33X) connected to a data acquisition system. The slope of pressure increase (dp/dt) in the permeate chamber became constant at the pseudo-steady state. The gas permeability (P) is calculated based on the following equation:

$$\begin{matrix}[ Math . 1 ] & \\ P = \frac{Vl}{A} \frac{{T}_{0}}{{p}_{f} {p}_{0} T} ( \frac{dp}{dt} ) & ( 1 )\end{matrix}$$

where P is the permeability of the gas through the membrane, in Barrer (1 Barrer=10₋¹⁰ cm³(STP)cm cm⁻² s⁻¹ cmHg⁻¹), V is the permeate volume (cm³), l is the thickness of the membrane (cm), A is the effective area of the membrane (cm²), p_{f} is the feed pressure (cmHg), p₀ is the pressure at standard state (76 cm-Hg), T is the absolute operating temperature (K), T₀ is the temperature at standard state (273.15 K), and (dp/dt) is the slope of pressure increase in the permeate volume at pseudo-steady state (cmHg/s).

The diffusion coefficient (D) for a specific gas can be derived from the thickness of the membrane and the time lag (θ):

$$\begin{matrix}[ Math . 2 ] & \\ D = \frac{{l}^{2}}{6 θ} & ( 2 )\end{matrix}$$

Then the solubility (S) can be derived from:

$$\begin{matrix}[ Math . 3 ] & \\ S = \frac{P}{D} & ( 3 )\end{matrix}$$

The ideal selectivity (α_{A/B}) of gas pairs, A and B, is defined as:

$$\begin{matrix}[ Math . 4 ] & \\ {α}_{A / B} = \frac{{P}_{A}}{{P}_{B}} = [ \frac{{D}_{A}}{{D}_{B}} ] [ \frac{{S}_{A}}{{S}_{B}} ] & ( 4 )\end{matrix}$$

where D_{A}/D_{B} is diffusion selectivity and S_{A}/S_{B} is the solubility selectivity.

The feed side pressure of the gases ranged from 4 to 10 bar. Permeability coefficients were calculated three times for each membrane. The error for the absolute values of the permeability coefficients could be estimated to about ±7%, due to uncertainties in determining the gas flux and membrane thickness. However, the reproducibility was better than ±5%.

### 3. Results

3-1. FT-IR Characterization

3-1-1. PIM-1/PDA Composite Membrane

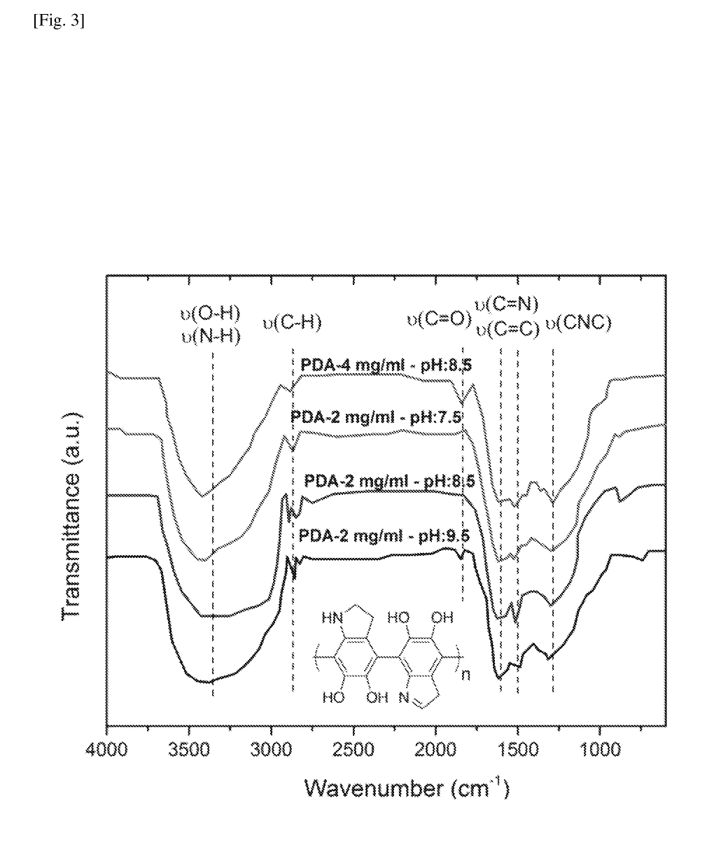

The FT-IR spectra of bulk PDAs prepared at different pH and concentrations are depicted in FIG. 3. The N—H and O—H stretching vibrations occur in a broad band at 3000 to 3700 cm Aliphatic C—H stretching mode is known to adsorb at about 2850 to 2950 cm⁻¹. A broad peak centered at 1600 cm⁻¹ is assigned to ν_{ring}(C═C) stretching vibrations. The PDA which is prepared in higher pH and concentration shows a band at 1710 cm that is related to ν(C═O) groups, indicating the presence of quinone groups. For the samples in lower pH and dopamine concentration, the 1710 cm feature decreases in relative intensity, indicating that carbonyl species are a minor component of the bulk PDA film. pH value of the dopamine solution can control the equilibrium between catechol and quinone groups. At higher pH, catechol groups of dopamine are easily deprotonated and oxidized to quinone groups which subsequently affect the microstructure, polarity and separation performance of polydopamine layers. Two features at 1620 and 1510 cm are assigned to ν_{ring}(C═C) and ν_{ring}(C═N) stretching modes, respectively, confirming the presence of aromatic amine species in the final PDA. The shoulder peak at 1350 cm is assigned to bicyclic ring CNC stretching modes. The presence of indole features in the bulk PDA supports the proposed structure of melanin-like polymers (polydopamine, dopamine-melanin) with 5,6-dihydroxyindole and/or 5,6-indolequinone units.

3-1-2. PIM-1/PANI Composite Membranes

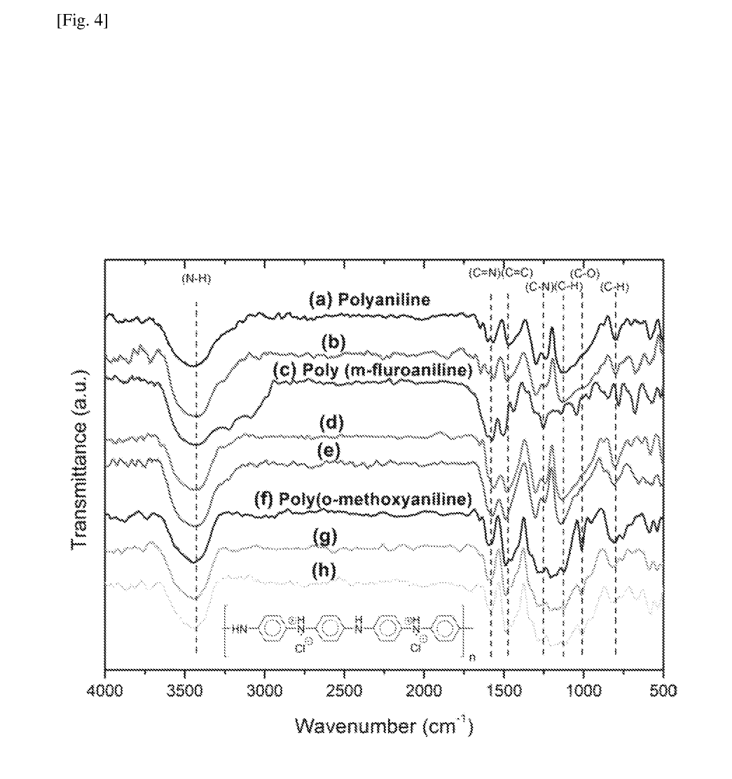

Formation of polyaniline (PANI) and derivatives thereof were also confirmed by FT-IR. FIG. 4 shows FTIR spectra of PANIs. In FIG. 4, (a) is a spectrum of polyaniline, (b) is a spectrum of poly(aniline-co-APBA) with an aniline to APBA molar ratio of 3:1, (c) is a spectrum of poly(m-fluoroaniline), (d) is a spectrum of poly(aniline-co-m-fluoroaniline) with an aniline to m-fluoroaniline molar ratio of 1:1, (e) is a spectrum of poly(aniline-co-m-fluoroaniline) with an aniline to m-fluoroaniline molar ratio of 3:1, (f) is a spectrum of poly(o-methoxyaniline), (g) is poly(aniline-co-o-methoxyaniline) with an aniline to o-methoxyaniline molar ratio of 1:1, and (h) is a spectrum of poly(aniline-co-o-methoxyaniline) with an aniline to o-methoxyaniline molar ratio of 3:1.

The polyaniline has several major bands at 3450, 1580, 1450, 1290 and 1128 cm⁻¹. The peak at 3450 cm⁻¹ is attributed to N—H stretching modes. The peaks at around 1580 and 1450 cm⁻¹ are attributed to C═N and C═C stretching modes for the quinoid and benzenoid rings. The bands at about 1290 and 1250 cm′ are related to C—N stretching of the benzenoid ring. The peaks at 1135 and 810 cm′ are assigned to the bending vibration of C—H, which is formed during protonation.

Poly(o-methoxyaniline) and copolymers thereof, together with aniline, showed bands at 1010 cm⁻¹ assigned to C—O—C stretching of alkyl aryl ether linkage. The spectra of (c), (d) and (e) present FTIR bands observed for poly(m-fluoroaniline) and poly(aniline-co-m-fluoroaniline) The absorption peak observed at 1170 cm⁻¹ has been associated with the presence of a halogen (fluoro) group in the poly(m-fluoroaniline) and the copolymers. These vibration bands are also showed in the infrared spectrum of PANI. However, a shift observed in the spectrum indicates the presence of fluoro moieties in the polymer chain.

3-2. Membrane Surface Characterization

3-2-1. PIM-1/PDA Composite Membranes

The water contact angle of the pure PIM-1 membrane was 86±2 degrees. The water contact angle of the PIM-1 membranes coated with PDA decreased to 42±2 degrees, after coating in 2 mg/ml dopamine solution for 120 minutes.

Coating with the PDA increases hydrophilicity of the PIM-1 membrane surface, which is seen as a decrease in contact angle. The hydrophilicity increased due to longer polymerization reaction time (coating time) or dopamine concentration in the dopamine solution. The hydroxyl, carboxylic acid, and amine functional groups of polydopamine are thought to contribute to the changes in the hydrophilicity of coated surfaces. Obviously, higher dopamine concentration could accelerate the growth of the PDA coating layer on the surface of the PIM-1 membrane and as a result decrease the contact angle amounts. These results confirmed the successful introduction of hydrophilic PDA coating layer onto the surface of the PIM-1 membranes.

Furthermore, XPS analysis was carried out to determine the elemental composition of the PDA coating layer of the composite membranes. Table 1 shows determined surface elemental compositions of the PIM-1 membrane and PIM-1/PDA composite membranes prepared at different pH and concentration of the dopamine solution. Atom percentages of analyzed elements in the coating layer that were calculated from the corresponding photoelectron peak area after corrections for the sensitivity factor are listed in Table 1.

TABLE 1

| Sample | Atom percentage (mol %) | | | | | |
|---|---|---|---|---|---|---|
| (Concentration | C | | | | | |
| (mg/ml)—pH) | C—H | C—N/C—OH | C═O | O | N | N/C |
| PIM-1 | 82 | | | 13 | 5 | 0.061 |
| PIM-1/PDA | 12.1 | 43.6 | 19.9 | 17 | 5.9 | 0.078 |
| 2 mg/ml-pH: 7.5 | | | | | | |
| PIM-1/PDA | 14.9 | 35.4 | 24.4 | 17.7 | 6.1 | 0.0817 |
| 2 mg/ml-pH: 8.5 | | | | | | |
| PIM-1/PDA | 15.9 | 32.7 | 27.3 | 18.7 | 5.4 | 0.0711 |
| 2 mg/ml-pH: 9.5 | | | | | | |
| PIM-1/PDA | 14.1 | 39.5 | 22.8 | 18.1 | 5.1 | 0.0668 |
| 1 mg/ml-pH: 8.5 | | | | | | |
| PIM-1/PDA | 19.1 | 39.3 | 23.2 | 14 | 3.8 | 0.046 |
| 4 mg/ml-pH: 8.5 | | | | | | |

By deconvolution of the C1s core level spectrum, three peaks at 287.5, 285.5, and 284.5 eV were identified, which were assigned to C═O, C—N/C—OH, and C—H, respectively. The results showed that the amount of C═O increased with higher pH of the dopamine solution, which suggested that a higher pH value might create more quinone functional groups. The binding energy at 532.4 eV was assigned to the oxygen from catechol and quinine form of the DPA.

3-2-2. PIM-1/PANI Composite Membranes

The water contact angle of the PIM-1 membranes coated with PANI decreased to 71±2 degrees, after 24 minutes polymerization reaction time (coating time). The amount of surface contact angle did not show any significant changes by increasing the reaction time to 30 minutes.

The elemental composition of the PANI coating layer was also determined by XPS analysis. Table 2 shows atomic percentages of analyzed elements in the coating layers, calculated from the corresponding photoelectron peak area after corrections for the sensitivity factor.

TABLE 2

| | Atom percentage (mol %) | | | | | | | |
|---|---|---|---|---|---|---|---|---|
| Sample | C | | | | | | | |
| (Concentration | | C—N/ | | | | | | |
| (mg/ml)—pH) | C—H | C═N | C═O | O | N | Cl | F | N/C |
| PIM-1 | 82 | | | 13 | 5 | 0 | 0 | 0.061 |
| PIM-1/PANI | 22.8 | 38.2 | 24.4 | 5.6 | 8.8 | 0.2 | 0 | 0.103 |
| PIM-1/ | 16.6 | 42.8 | 18.5 | 15.1 | 5.7 | 1.3 | 0 | 0.073 |
| poly(aniline-co- | | | | | | | | |
| methoxyaniline) | | | | | | | | |
| PIM-1/poly | 13.3 | 53.7 | 13.1 | 10.1 | 7.8 | 0.8 | 1.2 | 0.097 |
| (aniline-co- | | | | | | | | |
| m-fluoroaniline) | | | | | | | | |

The small amount of oxygen content, around 5%, in PANI structure can be derived from partial oxidation of the PANI surface or from weakly completed oxygen atoms. The elements carbon and nitrogen are from the PANI backbone whereas the element chlorine is a counter ion in the case of protonated PANI samples or due to traces of the acid (such as HCl) that was used during the polymerization process.

Oxygen content increased to 15% in the coating layer of poly(aniline-co-o-methoxyaniline) The apparent increase of the oxygen concentration can be due to the presence of ether alkyl groups in poly(aniline-co-o-methoxyaniline)

The XPS for poly(aniline-co-m-fluoroaniline) with molar ratio of 1:1 showed F (1s) peak centered close to 697 eV which is due to presence of fluorine groups on the surface of coated sample.

3-3. ATR-FTIR Analysis

The surface chemical structure of modified PIM-1/PDA composite membranes was further proved by ATR-FTIR.

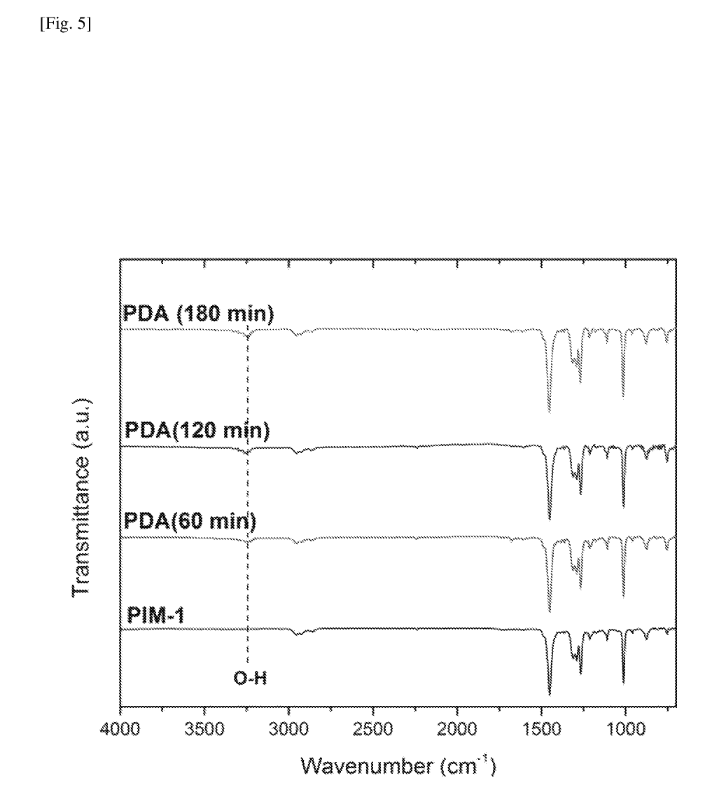

FIG. 5 shows ATR-FTIR spectra of pure PIM-1 membrane and PIM-1/PDA composite membranes prepared with reaction times of 60, 120, or 180 minutes. The absorbance of the original PIM-1 showed different peaks including C—H stretching within the methyl (C—CH₃) groups and methylene (CH₂) groups at around 2950, 2930 and 2840 cm⁻¹, C—H bending vibrations within methyl and methylene groups (1455 cm⁻¹), nitrile groups (—CN) at 2238 cm⁻¹, aromatic bending (C═C) at 1607 cm⁻¹, C—O stretching over 1300-1000 cm⁻¹, and the long wavelength bands corresponding to aromatic bending.

Upon depositing PDA, the PIM-1/PDA composite membranes show the hydroxyl (O—H) groups around 3300 cm⁻¹ simultaneously, and the intensity increased with reaction time. In the composite membranes, the thicknesses of the PDA coating layers are less than ATR-FTIR detective depth which is approximately several microns. In this case, the adsorption peak at 1607 cm⁻¹ is assigned to the overlap of C═C resonance vibration in aromatic ring of PIM-1 and N—H bending of PDA.

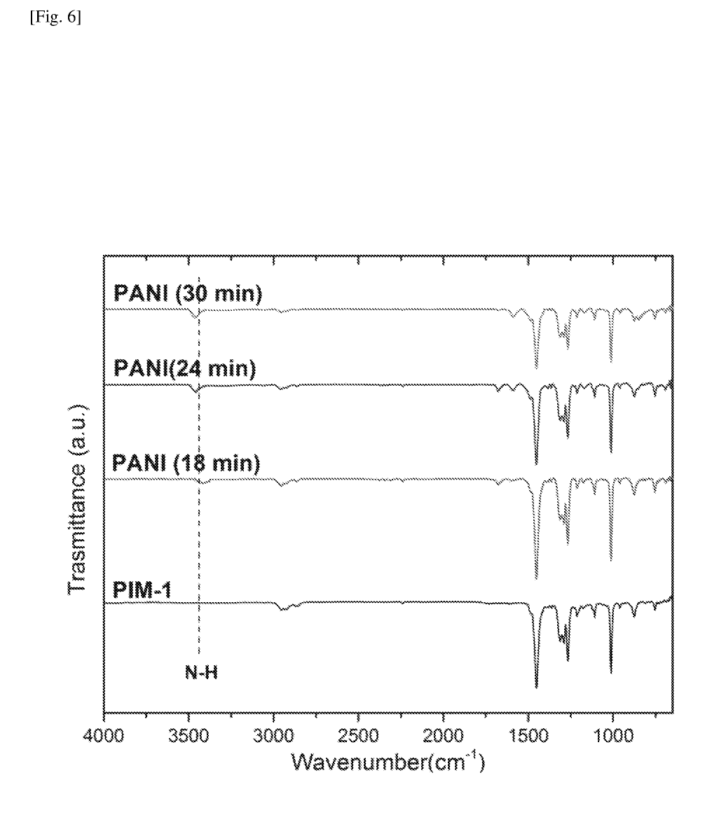

FIG. 6 shows ATR-FTIR spectra of pure PIM-1 membrane and PIM-1/PANI composite membranes prepared with reaction times of 18, 24, or 30 minutes. As with the PIM-1/PDA composite membranes, PIM-1/PANI composite membranes showed peaks at 3300 to 3450 cm⁻¹ related to N—H group of polyaniline. The intensity of these peaks increased with reaction time.

3-4. Morphology of Composite Membranes

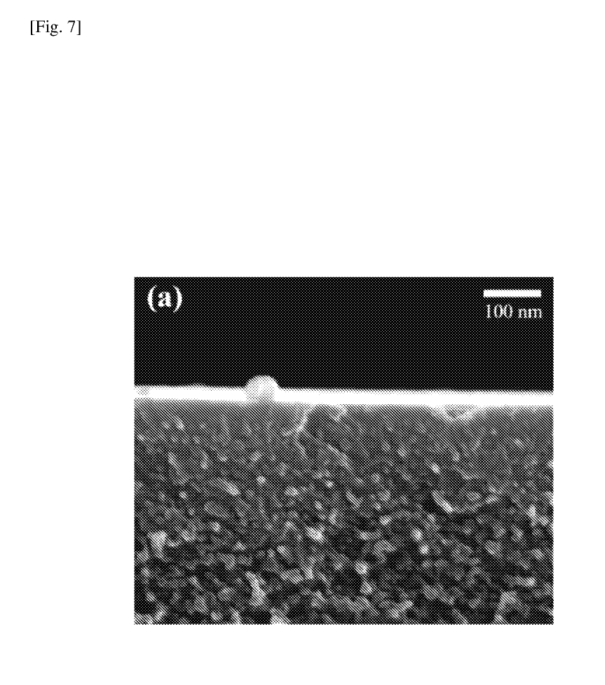

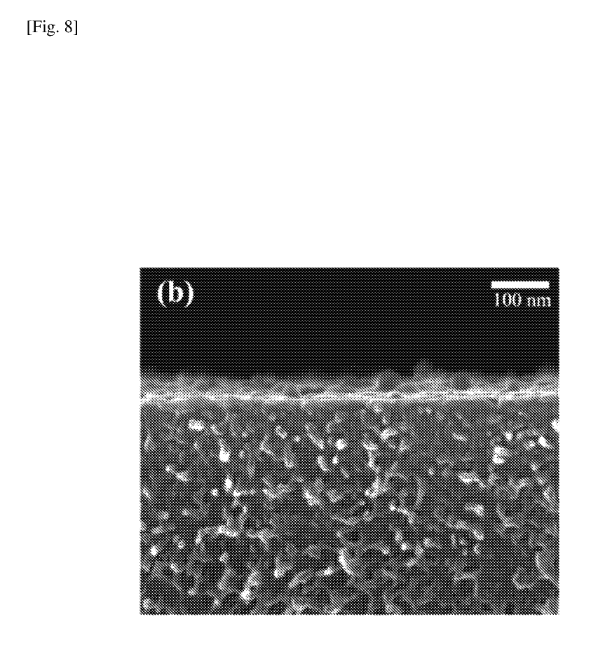

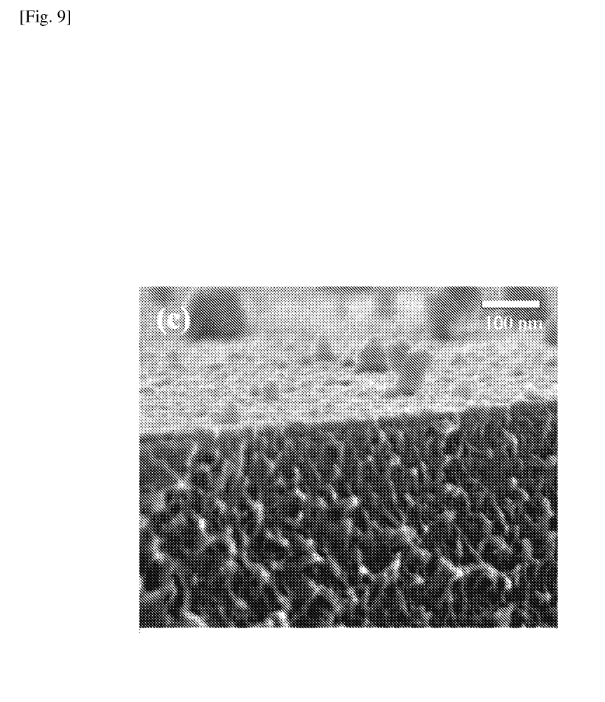

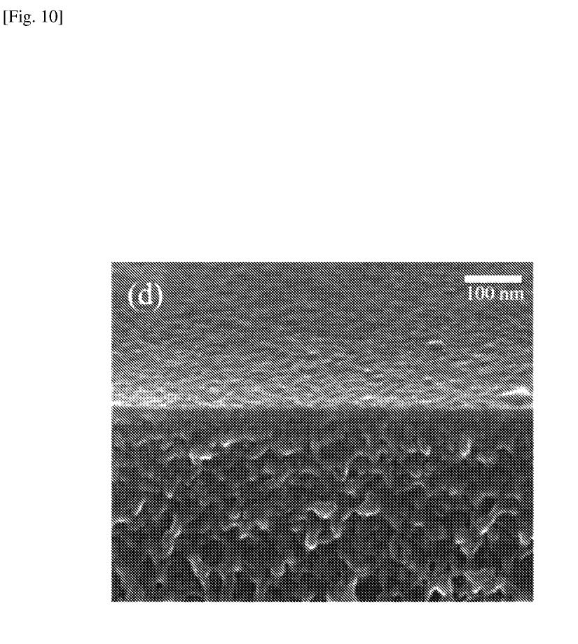

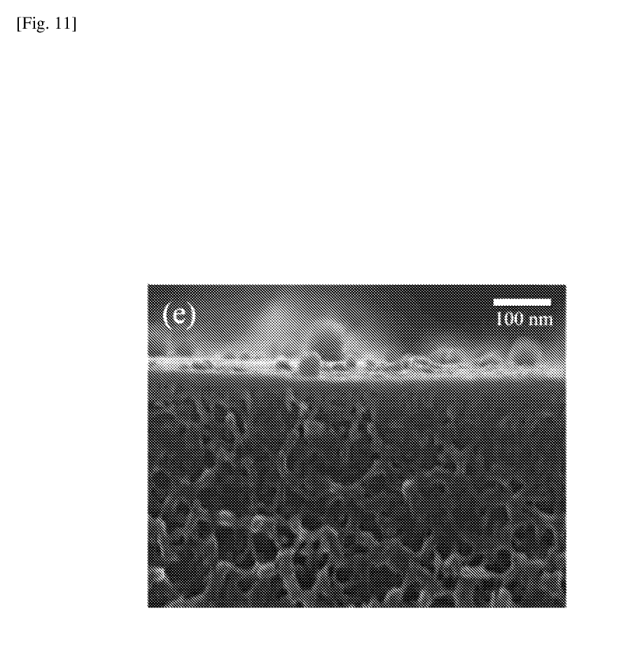

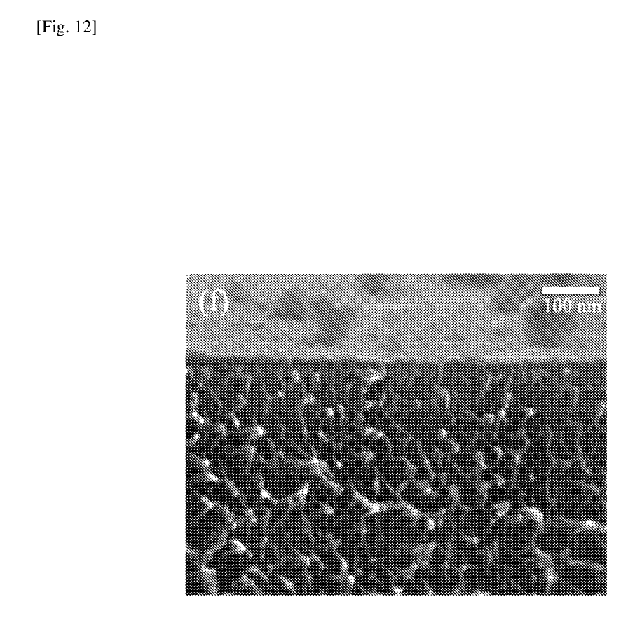

FIGS. 7 to 12 are SEM images of the cross sections of PIM-1/PDA composite membranes prepared with different dopamine concentrations and reaction times of 2.0 g/l and 30 minutes (FIG. 7); 2.0 g/l and 60 minutes (FIG. 8), 2.0 g/l and 90 minutes (FIG. 9), 2.0 g/l and 120 minutes (FIG. 10), 4.0 g/l and 120 minutes (FIG. 11), or 1.0 g/l and 120 minutes (FIG. 12).

The SEM images show the thin PDA coating layer formed on the surface of the PIM-1 membrane. The thicknesses of the PDA coating layer increased with an increase in reaction time and dopamine concentration. The thickness of the PDA coating layer increased approximately from 5 to 25 nm for 30 to 120 minutes reaction time in the samples which are prepared in a 2.0 g/L dopamine solution at pH 8.5. The SEM images show that PDA formed a distinctive layer on the pristine PIM-1 membrane surface and no appreciable defects were observed between the PDA coating layer and the PIM-1 membrane surface.

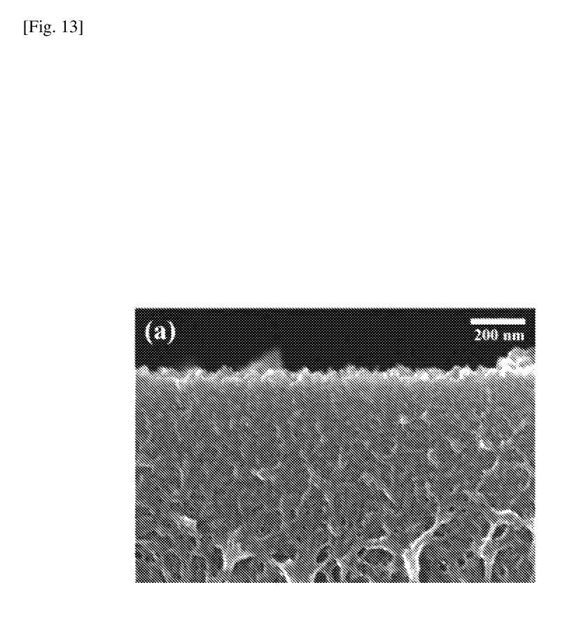

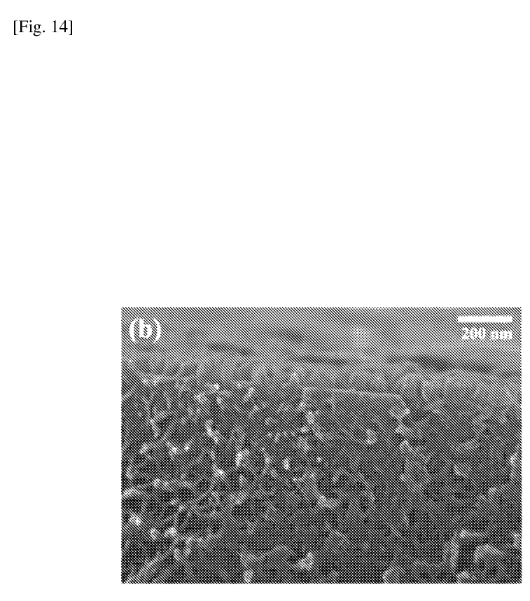

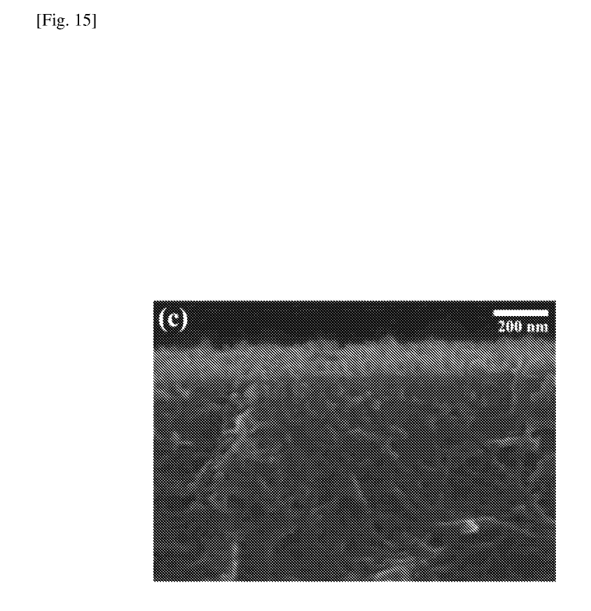

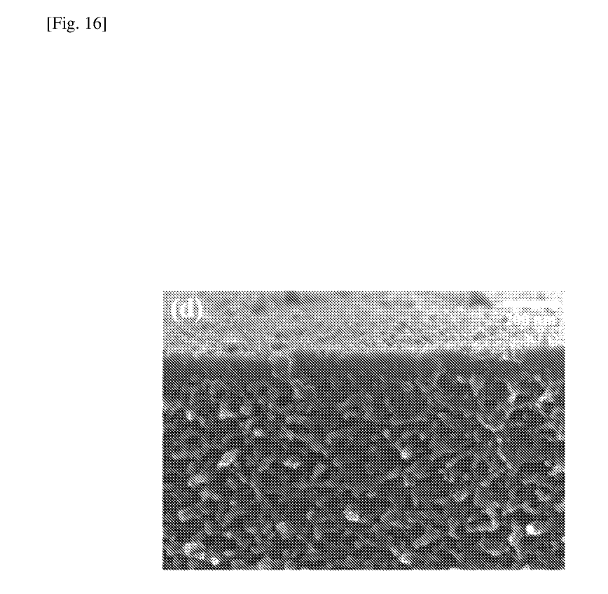

FIGS. 13 to 16 are SEM images of the cross sections of PIM-1/PANI composite membranes prepared with reaction times of 12 minutes (FIG. 13), 18 minutes (FIG. 14); 24 minutes (FIG. 15), or 30 minutes (FIG. 16). The thickness of PANI coating layer varied with reaction time in the range of 50 to 200 nm. All membranes exhibited a globular morphology with some precipitated PANI particles adhering to the surface. The average size of the globules was around 50 nm.

3-5. Gas Permeation Properties

3-5-1. PIM-1/PDA Composite Membranes

Single gas permeation properties of pure PIM-1, PIM-1/PDA and PIM-1/PANI composite membranes were evaluated with H₂, CO₂, O₂, N₂ and CH₄. Gas transport in a microporous PIM-1 polymer can be explained with the solution diffusion model, where the permeability coefficient (P) is a product of solubility (S) and diffusion coefficient (D).

Tables 3 to 7 show the pure gas permeability and ideal selectivity of the PIM-1/PDA membranes with different polymerization reaction times, dopamine concentrations and pH of the solution measured at 25 degrees C. and 4 bar.

TABLE 3

| Reaction | Permeability (Barrer) | | | | | Selectivity | | | | |
|---|---|---|---|---|---|---|---|---|---|---|
| time (min) | H₂ | CO₂ | O₂ | N₂ | CH₄ | O₂/N₂ | CO₂/N₂ | H₂/CO₂ | H₂/N₂ | H₂/CH₄ |
| 0 | 1716 | 3101 | 792 | 196 | 210 | 4.0 | 15.8 | 0.6 | 8.8 | 8.2 |
| 15 | 1709 | 1731 | 367 | 60.6 | 73 | 6.1 | 28.6 | 1.0 | 28.2 | 23.4 |
| 30 | 1461 | 664 | 152 | 28.6 | 22.5 | 5.3 | 23.2 | 2.2 | 51.2 | 65.0 |
| 45 | 877 | 142 | 57.4 | 8.9 | 13.1 | 6.5 | 15.9 | 6.2 | 98.6 | 67.0 |
| 60 | 736 | 74.9 | 43.3 | 7.3 | 10.7 | 5.9 | 10.3 | 9.8 | 101 | 68.7 |
| 75 | 694 | 49.6 | 19.6 | 6.7 | 9.8 | 2.9 | 7.4 | 14.0 | 104 | 70.8 |
| 90 | 643 | 25.8 | 16.1 | 5.7 | 8.8 | 2.8 | 4.5 | 24.9 | 113 | 73.0 |
| 120 | 578 | 20.1 | 11.8 | 4.3 | 6.5 | 2.7 | 4.7 | 28.8 | 134 | 88.9 |
| 150 | 466 | 10.4 | 6.8 | 2.7 | 5.1 | 2.5 | 3.9 | 44.8 | 173 | 91.3 |
| 180 | 306 | 8.1 | 4.9 | 1.4 | 2.5 | 3.5 | 5.8 | 37.8 | 219 | 122.4 |

The samples are prepared with a dopamine concentration of 2 mg/ml and pH 8.5 (4 bar and 25° C.)

TABLE 4

| Reaction | Permeability (Barrel) | | | | | Selectivity | | | | |
|---|---|---|---|---|---|---|---|---|---|---|
| time (min) | H₂ | CO₂ | O₂ | N₂ | CH₄ | O₂/N₂ | CO₂/N₂ | H₂/CO₂ | H₂/N₂ | H₂/CH₄ |
| 0 | 1716 | 3101 | 792 | 196 | 210 | 4.0 | 15.8 | 0.6 | 8.8 | 8.2 |
| 30 | 1245 | 438 | 126 | 30.1 | 23.7 | 4.2 | 14.6 | 2.8 | 41.4 | 52.5 |
| 60 | 1083 | 195 | 59.4 | 3.8 | 5.3 | 15.6 | 51.3 | 5.6 | 285 | 204 |
| 90 | 734 | 32.1 | 36.3 | 2.1 | 3.1 | 17.3 | 15.3 | 22.9 | 350 | 237 |
| 120 | 532 | 13.8 | 11.0 | 0.4 | 1.4 | 27.5 | 34.5 | 38.6 | 1330 | 380 |

The samples are prepared with a dopamine concentration of 4 mg/ml and pH 8.5 (4 bar and 25° C.)

TABLE 5

| Reaction | Permeability (Barrer) | | | | | Selectivity | | | | |
|---|---|---|---|---|---|---|---|---|---|---|
| time (min) | H₂ | CO₂ | O₂ | N₂ | CH₄ | O₂/N₂ | CO₂/N₂ | H₂/CO₂ | H₂/N₂ | H₂/CH₄ |
| 0 | 1716 | 3101 | 792 | 196 | 210 | 4.0 | 15.8 | 0.6 | 8.8 | 8.2 |
| 30 | 1675 | 961 | 247 | 44.1 | 52.6 | 5.9 | 21.7 | 1.7 | 38 | 31.8 |
| 60 | 1665 | 647 | 170 | 24.8 | 26.1 | 6.8 | 26.1 | 2.6 | 67.1 | 63.8 |
| 90 | 961 | 82.7 | 32.7 | 7.7 | 8.4 | 4.2 | 10.7 | 11.6 | 125 | 114 |
| 120 | 728 | 27.1 | 18.0 | 5.5 | 5.8 | 3.2 | 4.9 | 26.9 | 132 | 126 |

The samples are prepared with a dopamine concentration of 1 mg/ml and pH 8.5 (4 bar and 25° C.)

TABLE 6

| Reaction | | | | | | Selectivity | | | | |
|---|---|---|---|---|---|---|---|---|---|---|
| time | Permeability (Barrer) | | | | | O₂/ | CO₂/ | H₂/ | H₂/ | H₂/ |
| (min) | H₂ | CO₂ | O₂ | N₂ | CH₄ | N₂ | N₂ | CO₂ | N₂ | CH₄ |
| 0 | 1716 | 3101 | 792 | 196 | 210 | 4.0 | 15.8 | 0.6 | 8.8 | 8.2 |
| 30 | 1656 | 2596 | 592 | 159 | 182 | 3.7 | 16.3 | 0.6 | 10.4 | 9.1 |
| 60 | 1530 | 1278 | 350 | 107 | 104 | 3.3 | 12 | 1.2 | 14.3 | 14.7 |
| 90 | 1428 | 1002 | 232 | 39.6 | 50.2 | 5.8 | 25.3 | 1.4 | 36.1 | 28.5 |
| 120 | 1343 | 544 | 129 | 19.9 | 14.1 | 6.5 | 27.3 | 2.5 | 67.5 | 95.3 |

The samples are prepared with a dopamine concentration of 2 mg/ml and pH 7.5 (4 bar and 25° C.)

TABLE 7

| Reaction | Permeability (Barrer) | | | | | Selectivity | | | | |
|---|---|---|---|---|---|---|---|---|---|---|
| time (min) | H₂ | CO₂ | O₂ | N₂ | CH₄ | O₂/N₂ | CO₂/N₂ | H₂/CO₂ | H₂/N₂ | H₂/CH₄ |
| 0 | 1716 | 3101 | 792 | 196 | 210 | 4.0 | 15.8 | 0.6 | 8.8 | 8.2 |
| 30 | 1661 | 812 | 273 | 60.9 | 48.3 | 4.5 | 13.3 | 2.1 | 27.3 | 34.4 |
| 60 | 1205 | 246 | 76.3 | 12.6 | 21.4 | 6.1 | 19.5 | 4.9 | 95.6 | 56.3 |
| 90 | 918 | 99.6 | 16.6 | 3.4 | 9.1 | 4.9 | 29.3 | 9.2 | 270 | 101 |
| 120 | 829 | 36.7 | 14.3 | 2.1 | 7.5 | 6.8 | 17.5 | 22.6 | 395 | 111 |

The samples are prepared with a dopamine concentration of 2 mg/ml and pH 9.5 (4 bar and 25° C.)

When the reaction time increases, the H₂/CO₂, H₂/N₂, and H₂/CH₄ selectivities increase while their permeabilities decrease, indicating that the thickness of the PDA coating layer increases with the reaction time.

After formation of the PDA coating layer, the composite membranes showed significantly lower gas permeability for larger molecules like CO₂, O₂, N₂ and CH₄ by two orders of magnitude, while permeability of H₂ stayed very high. When the PDA coating layer is deposited for 150 minutes in a 2 mg/ml dopamine solution at pH 8.5, the H₂/CO₂ selectivity increased up to 45 with a high H₂ permeability of 466 Barrer (Table 3).

By increasing the thickness of the PDA coating layer in the composite membranes, the gas molecules with larger size are more restricted in terms of passing along the polymer thickness than the smaller ones, and thus their permeabilities will decrease more. Therefore, the lower reduction of H₂ permeability compared to other gases is due to the small molecular size.

The membranes modified under stronger alkaline conditions (i.e. pH values of 8.5 and 9.5) exhibited lower H₂ permeability and higher selectivity values than those modified at pH 7.5. The pH of the dopamine solution remained relatively constant during 120 minutes reaction time. Previous studies suggest that a dopamine polymerization reaction proceeds with oxidation of the catechol moieties to quinone functional group. This oxidation process and PDA growth rate accelerate in alkaline pH as the catechol/quinone equilibrium (pKa=9.2) favors the quinone. The higher CO₂ permeability of composite membranes coated in a pH value of 9.5 compared to those coated in pH 8.5 may be due to the presence of more polar quinone functional groups and their higher solubility towards condensable CO₂ gas.

Table 8 shows the solubility and diffusion coefficient for the PIM-1 membrane, and the PIM-1/PDA composite membrane prepared in a 2 mg/ml dopamine solution at pH 8.5 for 120 minutes at 4 bar and 25 degrees C. It was confirmed that the significant increase of gas selectivity is attributed to the increase in diffusion selectivity (D_{A}/D_{B}) while the solubility selectivity (S_{A}/S_{B}) is quite constant, in agreement with the expected surface modification of the PIM-1 surface to control microporous cavities.

TABLE 8

| | | | | | | Selectivity | | | | |
|---|---|---|---|---|---|---|---|---|---|---|
| Separation | Permeance (Barrer) | | | | | O₂/ | CO₂/ | H₂/ | H₂/ | H₂/ |
| Parameters | H₂ | CO₂ | O₂ | N₂ | CH₄ | N₂ | N₂ | CO₂ | N₂ | CH₄ |
| Critical | 33.2 | 304.2 | 154.6 | 126.3 | 190.9 | | | | | |
| temperature | | | | | | | | | | |
| (K) | | | | | | | | | | |
| Kinetic | 2.89 | 3.30 | 3.46 | 3.64 | 3.8 | | | | | |
| diameter (Å) | | | | | | | | | | |
| PIM-1 | | | | | | | | | | |
| P (Barrer) | 1716 | 3101 | 791.9 | 196.10 | 210.1 | 4.04 | 15.81 | 0.55 | 8.75 | 8.17 |
| S | 7.02 | 256.3 | 40.1 | 22.4 | 106.1 | 1.79 | 11.45 | 0.03 | 0.31 | 0.07 |
| [10⁻³ cm⁻³ | | | | | | | | | | |
| cm⁻³ cmHg⁻¹] | | | | | | | | | | |
| D | 2446 | 121.0 | 197.6 | 87.6 | 19.8 | 2.26 | 1.38 | 20.21 | 27.92 | 123.54 |
| [10⁻⁸ cm² s⁻¹] | | | | | | | | | | |
| PIM-1/PDA* | | | | | | | | | | |
| P (Barrer) | 577.9 | 20.1 | 11.80 | 4.3 | 6.5 | 2.74 | 4.67 | 28.75 | 134.4 | 88.91 |
| S | 7.9 | 251.3 | 38.1 | 15.9 | 108.3 | 2.39 | 15.78 | 0.03 | 0.49 | 0.07 |
| [10⁻³ cm⁻³ | | | | | | | | | | |
| cm⁻³ cmHg⁻¹] | | | | | | | | | | |
| D | 734.5 | 0.8 | 3.10 | 2.7 | 0.6 | 1.15 | 0.30 | 918.13 | 272.0 | 1224.2 |
| [10⁻⁸ cm² s⁻¹] | | | | | | | | | | |

The PIM-1/PDA sample is prepared with a dopamine concentration of 2 mg/ml, pH 8.5 and 120 min coating time (4 bar and 25° C.)

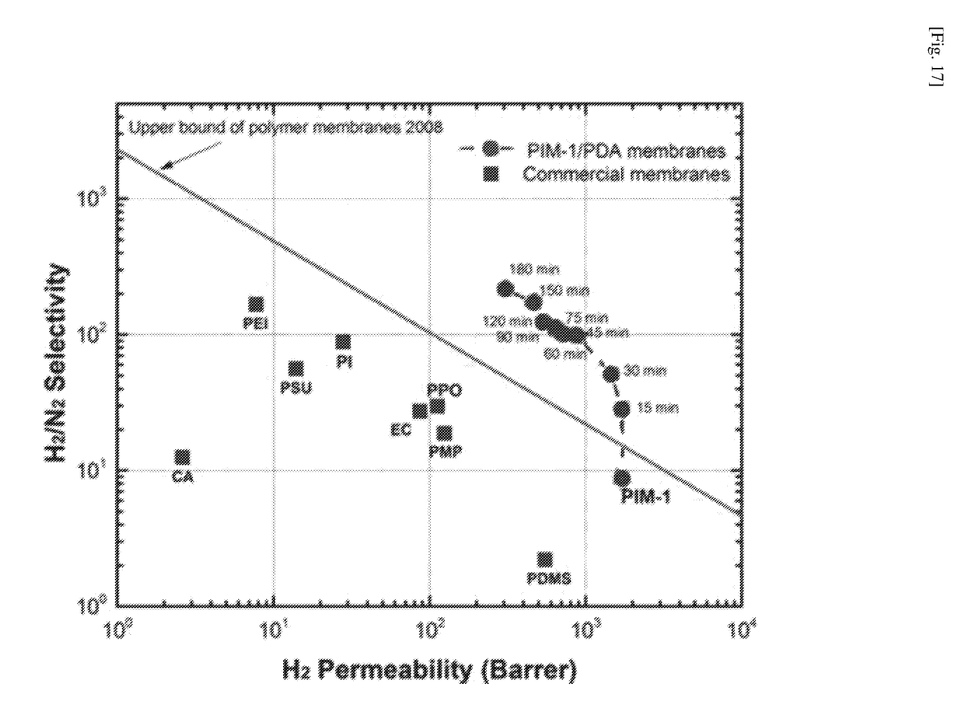

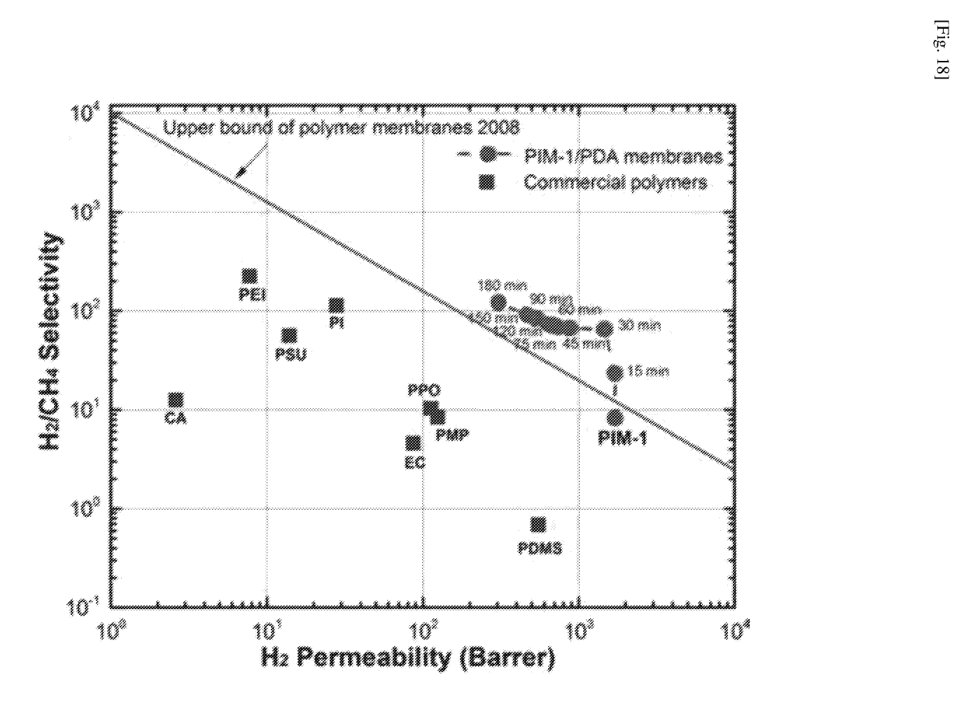

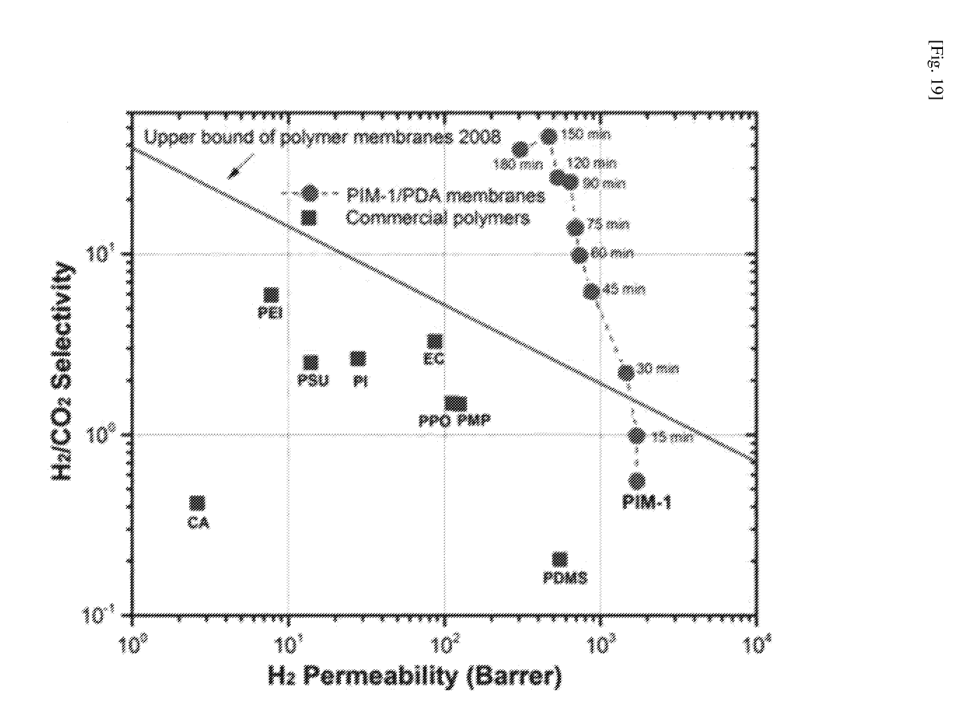

FIGS. 17 to 19 show relationships between H₂ selectivity and H₂ permeability for various polymer membranes including PIM/PDA composite membranes. In the figures, a line showing upper bound for polymeric membranes defined by Robeson in 2008 is presented. The significantly enhanced gas permeation properties of PIM-1/PDA membranes surpass the limitations defined by Robeson. The hydrogen separation performance of PIM-1/PDA membranes seems to be higher than all existing polymer membranes.

3-5-2. PIM-1/PANI Composite Membranes

Aniline Homopolymer (Polyaniline)

Table 9 shows the permeability for H₂, CO₂, O₂, N₂ and CH₄ gases through PIM-1/PANI composite membranes doped with HCl over different reaction times.

TABLE 9

| Reaction | | | | | | Selectivity | | | | |
|---|---|---|---|---|---|---|---|---|---|---|
| time | Permeability (Barrer) | | | | | O₂/ | CO₂/ | H₂/ | H₂/ | H₂/ |
| (min) | H₂ | CO₂ | O₂ | N₂ | CH₄ | N₂ | N₂ | CO₂ | N₂ | CH₄ |
| 0 | 1716 | 3101 | 791.8 | 196.1 | 210.1 | 4.0 | 15.8 | 0.6 | 8.8 | 8.2 |
| 22 | 527 | 353 | 87.7 | 12.8 | 9.9 | 6.9 | 27.6 | 1.5 | 41.2 | 53.2 |
| 24 | 519 | 224 | 80.8 | 9.9 | 6.9 | 8.2 | 22.6 | 2.3 | 52.4 | 75.2 |
| 26 | 491 | 142 | 71.7 | 6.8 | 4.7 | 10.5 | 21 | 3.5 | 72.2 | 104.5 |
| 28 | 472 | 74.6 | 35.6 | 3.6 | 3.9 | 9.9 | 20.7 | 6.3 | 131.1 | 121 |
| 30 | 450 | 69.7 | 21.1 | 2.8 | 2.8 | 7.5 | 24.9 | 6.5 | 161 | 160.7 |

Permeation tests done at 4 bar and 25° C.

The enhanced permeation of O₂ over N₂ suggests that the PIM-1/PANI composite membranes could be effective in separating O₂ from air, which is challenging since N₂ (3.64 angstrom) is only slightly larger than O₂ (3.47 angstrom). For example, the ideal O₂/N₂ selectivity value obtained for the PIM-1/PANI composite membrane with a 26-minute reaction time is 10.6, which is higher than commercially available polysulfone and polyimide membranes with O₂/N₂ selectivity of 4 to 8. It was found that the PIM-1/PANI composite membranes exhibited higher selectivity values for polar (or quadrupolar)/non polar gas pairs (e.g. H₂/CO₂, CO₂/O₂ and H₂/CH₄). This could be explained by the interaction between polar gases and the polymeric matrix.

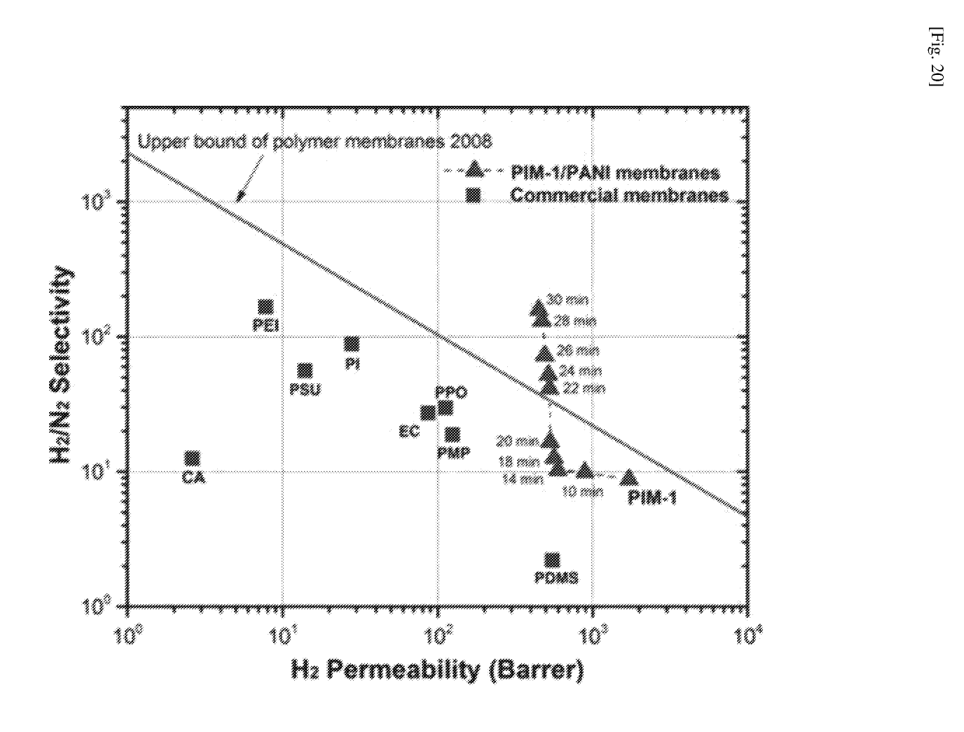

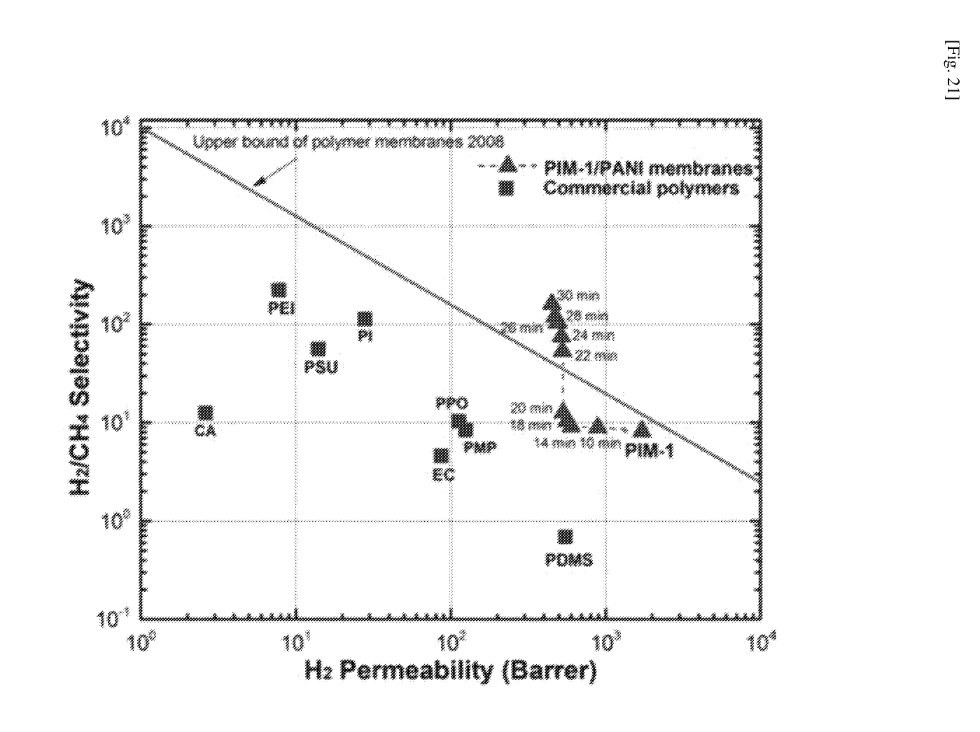

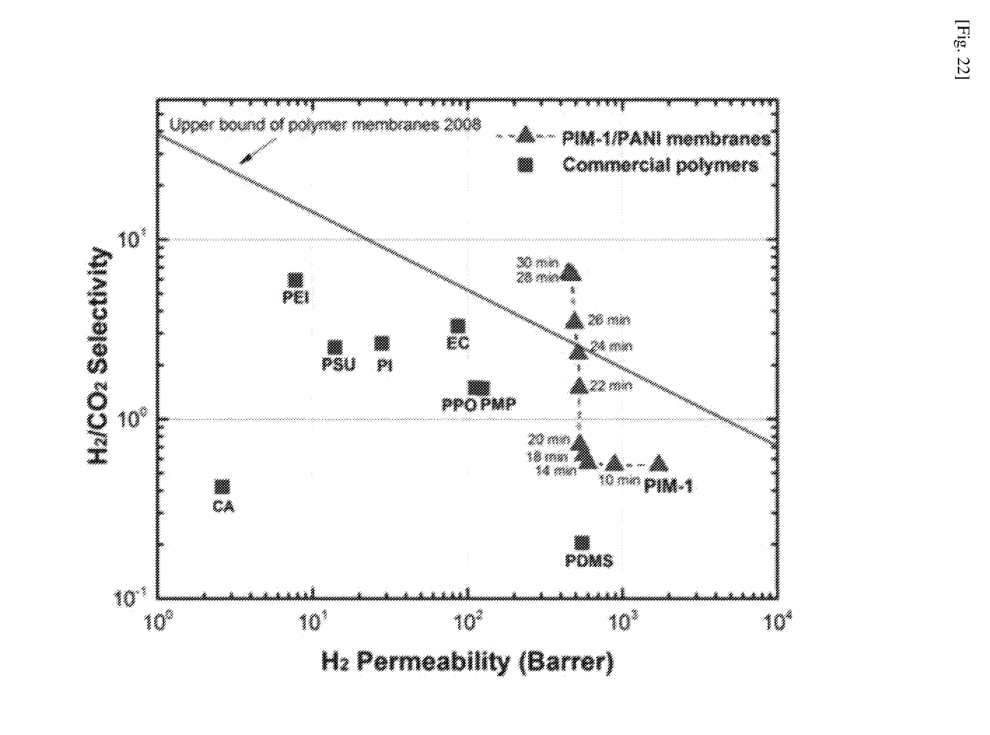

FIGS. 20 to 22 show relationships between H₂ selectivity and H₂ permeability for various polymer membranes including PIM/PANI composite membranes. In the figures, a line showing upper bound for polymeric membranes defined by Robeson in 2008 is presented. The significantly enhanced gas permeation properties of PIM-1/PDA membranes surpass the limitations defined by Robeson.

Polyaniline Derivatives

Table 10 shows the permeability for H₂, CO₂, O₂, N₂ and CH₄ gases through PIM-1/PANIs composite membranes doped with HCl. The evaluated membranes are prepared over a 24-minute reaction time at 4 bar and 25 degrees C. These membranes with copolymers also exhibited high H₂ selectivity.

TABLE 10

| Monomers | Permeability (Barrer) | | | | | Selectivity | | | | |
|---|---|---|---|---|---|---|---|---|---|---|
| (mol %) | H₂ | CO₂ | O₂ | N₂ | CH₄ | O₂/N₂ | CO₂/N₂ | H₂/CO₂ | H₂/N₂ | H₂/CH₄ |
| aniline | 519 | 224 | 80.2 | 10 | 6.9 | 8.1 | 22.6 | 2.3 | 52.2 | 75.2 |
| aniline (50)/ | 422 | 124 | 34.6 | 16.6 | 14.4 | 2.1 | 7.5 | 3.4 | 25.4 | 29.3 |
| o-anisidine | | | | | | | | | | |
| (75) | | | | | | | | | | |
| aniline (50)/ | 542 | 120 | 42.1 | 7.9 | 10.4 | 5.3 | 15.2 | 4.5 | 68.6 | 52.0 |
| o-anisidine | | | | | | | | | | |
| (50) | | | | | | | | | | |
| aniline (25)/ | 601 | 161 | 72.8 | 10.2 | 7.3 | 7.2 | 15.8 | 3.7 | 59.0 | 82.7 |
| m-fluoroaniline | | | | | | | | | | |
| (75) | | | | | | | | | | |
| aniline (50)/ | 1066 | 548 | 152 | 25.8 | 15.8 | 5.9 | 21.3 | 2 | 41.4 | 67.6 |
| m-fluoroaniline | | | | | | | | | | |
| (50) | | | | | | | | | | |
| aniline (50)/ | 1168 | 614 | 158 | 21.5 | 15.6 | 7.4 | 28.6 | 1.9 | 54.5 | 74.9 |
| APBA (50) | | | | | | | | | | |

Reaction time: 24 minutes (Permeation tests at 4 bar and 25° C.)

Dopant Species

Table 11 shows the permeability for H₂, CO₂, O₂, N₂ and CH₄ gases through PIM-1/PANI composite membranes doped with HCl, HBr or HI. The evaluated membranes are prepared over a 24-minute reaction time at 4 bar and 25 degrees C. The composite membranes doped with HBr or HI exhibited high H₂ selectivity also exhibited high H₂ selectivity.

TABLE 11

| | | | | | | Selectivity | | | | |
|---|---|---|---|---|---|---|---|---|---|---|
| | Permeability (Barrer) | | | | | O₂/ | CO₂/ | H₂/ | H₂/ | H₂/ |
| Dopant | H₂ | CO₂ | O₂ | N₂ | CH₄ | N₂ | N₂ | CO₂ | N₂ | CH₄ |
| HCl | 519 | 224 | 80.8 | 9.9 | 6.9 | 8.1 | 22.6 | 2.3 | 52.2 | 75.2 |
| HBr | 531 | 248 | 83.7 | 17.8 | 16.1 | 4.7 | 13.9 | 2.1 | 29.8 | 33 |
| HI | 541 | 291 | 94.0 | 18.1 | 17.3 | 5.2 | 16.1 | 1.9 | 29.8 | 31.3 |

Reaction time: 24 minute (Permeation tests at 4 bar and 25° C.)

3-6. Mixed Gas Permeation Properties

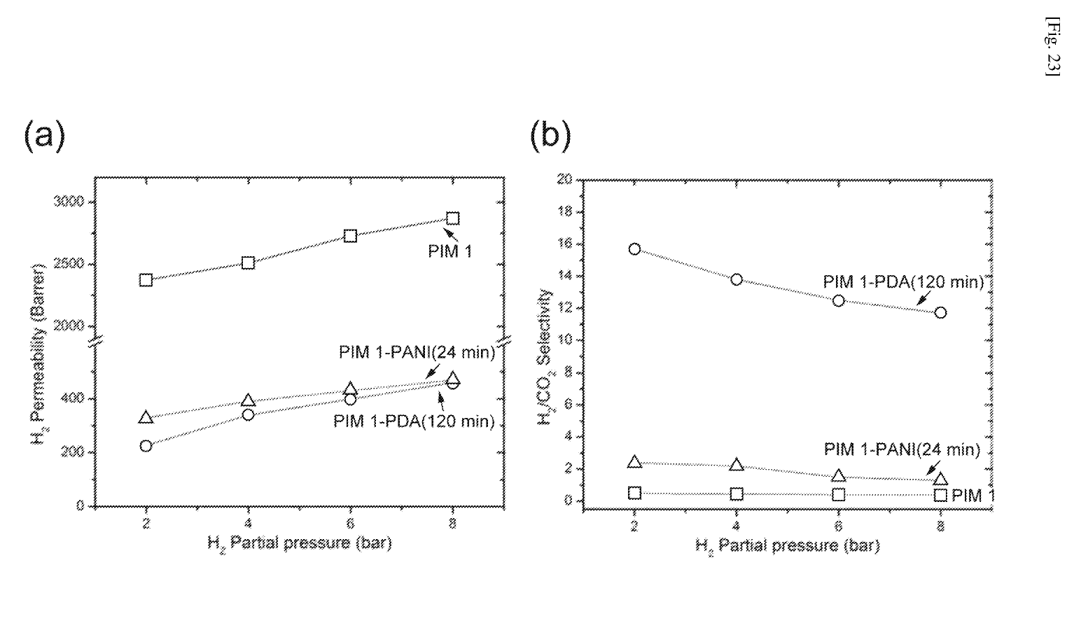

FIG. 23 shows pressure dependence of H₂ permeability, and H₂/CO₂ selectivity from H₂/CO₂ mixed gas through PIM-1 membrane, PIM-1/PDA and PIM-1/PANI composite membranes. (a) shows H₂ permeability, and (b) shows H₂/CO₂ selectivity. The evaluated PIM-1/PDA and PIM-1/PANI composite membranes were prepared by 24-minute and 120-minute coating time, respectively. Feed gas was standard gas mixtures of H₂/CO₂ (50/50 vol. %) at 25 degrees C. The H₂ permeabilities increased with pressure. The condensable CO₂ acts as a plasticizer that enhances chain mobility and opens the microstructure of PIM-1 and the coating layers (PDA or PANI), and consequently increases the diffusion coefficient of H₂ gas under the mixed-gas conditions. The composite membranes exhibited high H₂ selectivity for the H₂/CO₂ mixed gas.

### 4. PTMSP/PDA and PTMSP/PANI Composite Membranes

4-1. PTMSP Membrane Preparation

6 wt. % solution of PTMSP in cyclohexene was cast on a glass substrate and covered, within a clean chamber at room temperature under atmospheric pressure, in order to slowly evaporate the solvent. After 2 days, the resulting membrane was dried in a vacuum oven at 110 degrees C. overnight. Thickness of the membranes was around 80 micrometers as measured by a micrometer caliper.

4-2. PTMSP/PDA Composite Membrane Preparation

A similar methodology has been utilized for coating of 80 micrometers PTMSP membranes (pH 8.5 and 2 mg/ml dopamine concentration) with PDA. The coating time was 60, 120, 180, or 48 minutes.

4-3. PTMSP/PANI Composite Membrane Preparation

A similar methodology has been utilized for coating of 80 micrometers PTMSP membranes (similar concentrations) with PANI. The coating time was 24, 30, or 36 minutes.

4-4. Gas Permeation Properties

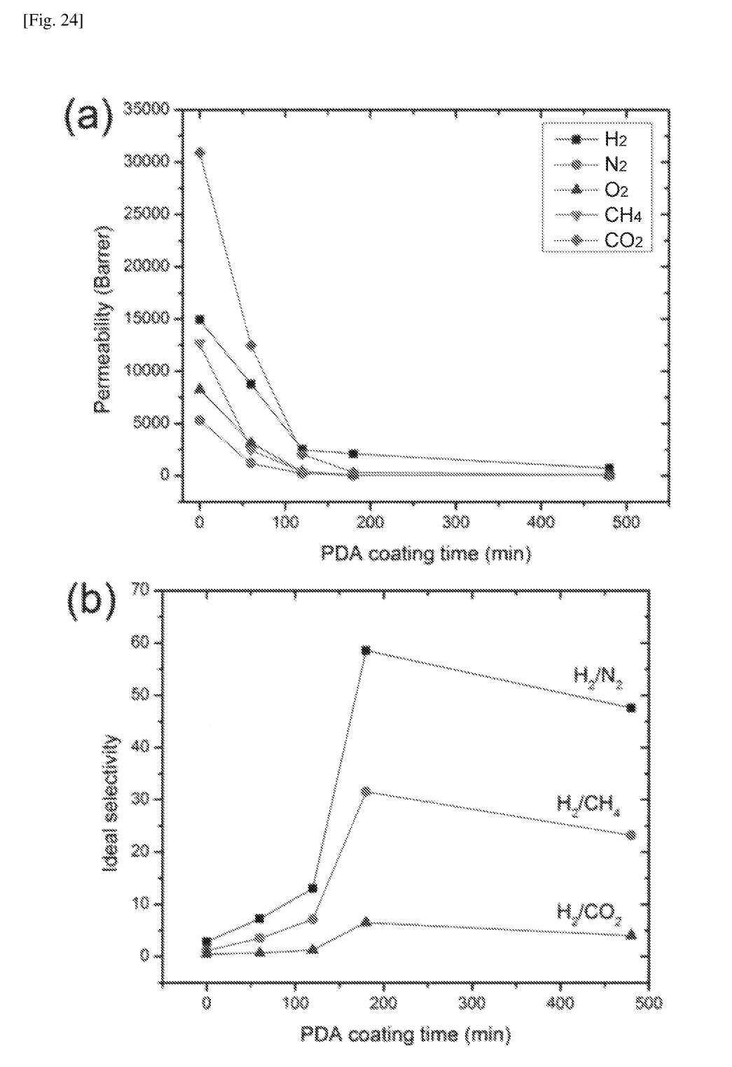

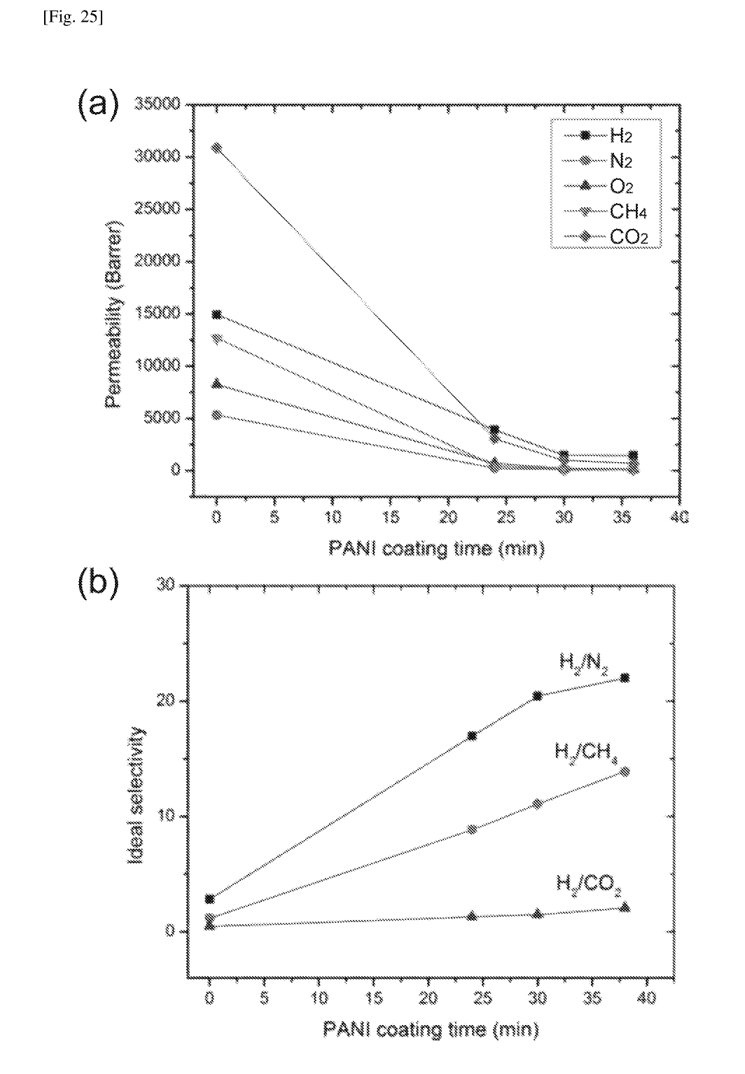

FIGS. 24 and 25 show single gas permeation properties of PTMSP/PDA and PTMSP/PANI composite membranes at 25 degrees C. as a function polymerization reaction time (coating time) to deposit PDA or PANI on the PTMSP membrane. The H₂ gas permeability of the prepared pure PTMSP membrane was 14935 Barrer at 25 degrees C. The decreases in gas permeability of different gases (H₂, N₂, O₂, CH₄ and CO₂) are related to the increase in the thickness of the PDA or PANI coating layers on the surface of high permeability PTMSP membrane. The presence of the PDA or PANI coating layers also led to significant H₂ selectivity improvement.

### 5. Thin Film Composite Membranes

PIM-1/PDA and PIM-1/PANI composite membranes supported on a porous PVDF substrate were also explored. In order to avoid interactions between porous substrate and polymerization solutions, holders with a structure shown in FIG. 2 were used. In these holders, the polymerization solution is just in contact with the surface of PIM-1 membrane, which can decrease the growth of cracks and defects on the surface of the thin PIM-1 membranes.

Table 12 summarizes the pressure normalised flux values (permeance) for various gases and separation factors through composite membranes. Comparative analysis of permeability selectivity of gas pairs revealed an increase in H₂ selectivity of the membranes. For example, samples which are coated with PDA for 120 minutes and coated with PANI for 30 minutes showed H₂/CO₂ selectivity of about 7 and 4.2, respectively.

TABLE 12

| | Permeance (10⁻⁵ mol/m² s | | | | | Selectivity | | | | |
|---|---|---|---|---|---|---|---|---|---|---|
| Reaction | kPa) | | | | | O₂/ | CO₂/ | H₂/ | H₂/ | H₂/ |
| time (min) | H₂ | CO₂ | O₂ | N₂ | CH₄ | N₂ | N₂ | CO₂ | N₂ | CH₄ |
| PIM-1 | 3.4 | 7.8 | 1.65 | 0.51 | 0.62 | 3.24 | 15.29 | 0.44 | 6.67 | 5.48 |
| PIM-1/PDA | | | | | | | | | | |
| 30 min | 2.1 | 1.85 | 0.37 | 0.09 | 0.15 | 4.11 | 20.56 | 1.14 | 23.33 | 14.00 |
| 60 min | 0.41 | 0.17 | 0.032 | 0.02 | 0.022 | 1.59 | 8.50 | 2.41 | 20.50 | 18.64 |
| 120 min | 0.24 | 0.034 | 0.021 | 0.017 | 0.019 | 1.22 | 2.00 | 7.06 | 14.12 | 12.63 |
| PIM-1/PANI | | | | | | | | | | |
| 14 min | 1.6 | 1.91 | 0.35 | 0.13 | 0.22 | 2.69 | 14.69 | 0.84 | 12.31 | 7.27 |
| 24 min | 0.35 | 0.23 | 0.027 | 0.018 | 0.018 | 1.50 | 12.78 | 1.52 | 19.44 | 19.44 |
| 30 min | 0.21 | 0.05 | 0.015 | 0.012 | 0.015 | 1.25 | 4.17 | 4.20 | 17.50 | 14.00 |

Permeation tests done at 4 bar and 25° C.

### 6. Conclusion

The experimental results confirmed that coating the surface of high free volume polymers such as PIM-1 and PTMSP membranes with PDA and PANI by oxidative polymerization results in a highly hydrogen-selective composite material without significant decrease in gas permeability. Accordingly, pure-gas permeation experiments showed an approximately eighty- and twenty-fold increase in H₂/CO₂ selectivity over PIM-1 in PIM-1/PDA and PIM-/PANI composite membranes, respectively. The concept presented here could offer a direction on improving the separation performance of other microporous polymer membranes.

1. A composite membrane comprising:
a polymeric membrane having an H₂ permeability of 500 Barrer or more at 25 degrees C.; and
a coating layer deposited on the polymer membrane, the coating layer being formed by oxidative polymerization.

2. The composite membrane according to claim 1,
the coating layer comprising: polydopamine; and/or an aniline-based polymer containing aniline and/or an aniline derivative as a monomer unit.

3. The composite membrane according to claim 1,
wherein a thickness of the coating layer is 500 nm or less.

4. The composite membrane according to claim 1,
further comprising a porous substrate, the polymeric membrane and the coating layer being stacked in that order on the porous substrate.

5. A method of fabricating the composite membrane according to claim 1, the method comprising:
depositing a coating layer on a polymeric membrane by oxidative polymerization, the polymeric membrane having an H₂ permeability of 500 Barrer or more at 25 degrees C.

6. A method of separating H₂ from a mixed gas, comprising:
causing H₂ in the mixed gas to pass through the composite membrane according to claim 1.
